(19) United States
(12) Patent Application Publication
(10) Pub. No.: US 2019/0035024 A1
(43) Pub. Date: Jan. 31, 2019

(54) SYSTEM AND METHOD FOR USING INVESTMENT OPPORTUNITIES TO PROMOTE CONSUMER LOYALTY

(71) Applicant: Syed J. Khadir, Spring, TX (US)

(72) Inventor: Syed J. Khadir, Spring, TX (US)

(21) Appl. No.: 15/677,063

(22) Filed: Aug. 15, 2017

Related U.S. Application Data
(63) Continuation of application No. 15/663,257, filed on Jul. 28, 2017, now abandoned.

(51) Int. Cl. G06Q 40/06; G06Q 40/04; G06Q 50/00

(52) U.S. Cl. CPC G06Q 40/06; G06Q 50/01; G06Q 40/04

(57) ABSTRACT

Systems, methods, and computer program products for facilitating the ability of one or more profit generating or nonprofit enterprises to increase consumer loyalty are disclosed. In an aspect, such consumer loyalty may be increased by enabling enterprises to use the systems, methods, and computer program products of the present disclosure to offer users a chance to receive one or more investment opportunities as a reward for purchasing, obtaining, utilizing, and/or obtaining the benefit of the products and/or services of a given enterprise and/or interacting with an enterprise via one or more websites, blogs, and/or social media networks. In some aspects, the one or more investment opportunities may comprise a chance to obtain one or more shares of stock associated with an enterprise. By obtaining at least partial ownership of an enterprise, a user may be incentivized to interact with that enterprise both now and in the future and/or encourage friends, family members, and/or acquaintances to do business with the enterprise in order to increase the value of the user's stock(s).

### CROSS-REFERENCE TO RELATED APPLICATION

The present application is a Continuation of U.S. patent application Ser. No. 15/663,257, entitled “SYSTEM AND METHOD FOR USING INVESTMENT OPPORTUNITIES TO INCENTIVIZE CONSUMER LOYALTY,” by Khadir, filed on Jul. 28, 2017, which is incorporated by reference herein in its entirety.

### FIELD OF THE DISCLOSURE

The present disclosure generally relates to consumer loyalty rewards programs and more particularly to systems, methods, and computer program products for facilitating the distribution of at least one investment opportunity to a user as a reward for the user utilizing a given enterprise's products and/or services.

### BACKGROUND

The statements in this section merely provide background information related to the present disclosure and may not constitute prior art.

A given enterprise typically requires members, patrons, sponsors, consumers, and/or other users in order to be successful. Whether the enterprise is a retail business, restaurant, gym, or some other profit generating establishment or nonprofit organization, various types of users must be convinced to use the types of products and/or services offered by a particular enterprise and, furthermore, the user(s) must be convinced to use the enterprise's products/services in favor of the products/services offered by competitors.

One way to incentivize users to engage in business or other dealings with one enterprise over others is by offering a type of loyalty rewards program. Many types of loyalty rewards programs currently exist that offer various types of rewards to users who select a particular enterprise to fulfill one or more needs. For example, many retail stores offer transaction cards (such as store debit or credit cards) to members and/or customers that may be used to receive product or service discounts, and many airlines offer miles or points to passengers that may be redeemed for discounts on airfare. While these types of loyalty rewards programs have been implemented with a degree of success, they are not as effective as they could be in that many users are likely to abandon a given enterprise's loyalty rewards program (and the accompanying products/services) as soon as a different enterprise offers superior incentives for rewarding consumer loyalty.

Additionally, many enterprises offer products/services in the form of software and/or various computer applications. Users often must pay to use such software/application(s), wherein such payment may be based on how much data is used by the software/application(s) during a period of use or how long a user uses the software/application(s); additionally, in some cases, users may pay to purchase a license to use the software/application(s) indefinitely. There currently does not exist a way for enterprises to effectively reward this kind software/application usage; thus, many users routinely seek out the cheapest software/application alternatives that are capable of fulfilling a given need with little or no regard to loyalty to the enterprise(s) providing the software/application(s).

Furthermore, as social media becomes increasingly integrated with our daily lives, more and more enterprises are developing a presence on social networking sites (such as Facebook®, available from Facebook, Inc. of Menlo Park, Calif.) in addition to developing their own websites and/or blogs. While these various online sites are a great way for enterprises to connect and interact with users, currently available loyalty rewards programs do not take full potential of such interaction. If users were more motivated to engage with an enterprise's various online site(s), then the users may be more inclined to “Like,” share, “Retweet®” (a form of reposted social media content offered by Twitter Inc. of San Francisco, Calif.), and/or otherwise validate the enterprise's online social media content. This, in turn, may help the enterprise obtain a greater web presence and thereby attract even more users.

Given the foregoing, what is needed are systems, methods, and computer program products that facilitate the ability of an enterprise to effectively generate and/or increase user loyalty by rewarding user(s) of the enterprise's products and/or services with one or more investment opportunities. Additionally, systems, methods, and computer program products that facilitate the ability of an enterprise to offer user loyalty rewards in the form of one or more investment opportunities that deter the user(s) from abandoning the enterprise's products/services for those of a competitor, even when the competitor offers a consumer loyalty rewards program of its own, are needed. Systems, methods, and computer program products that facilitate the ability of an enterprise to reward user(s) for using software and/or application(s) offered by the enterprise are also desired, as are systems, methods, and computer program products that facilitate the ability of an enterprise to reward users for engaging with the enterprise via one or more forms of online media.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products which facilitate the ability of one or more enterprises (e.g., retail stores, restaurants, gyms, businesses, etc.) to implement an effective consumer loyalty rewards program targeted towards one or more users (e.g., patrons, members, sponsors, consumers, customers, etc.) of the enterprise's products and/or services. Specifically, in an aspect, systems, methods, and computer program products are disclosed that present an enterprise's user(s) with one or more investment opportunities upon the completion of at least one enterprise transaction and/or interaction that may allow the user(s) to select and obtain one or more wealth generating investments in order to encourage the user(s) to do business with the enterprise now and to return to do business with the enterprise in the future (as well as recruit others to do business with the enterprise), even when competing enterprises may offer consumer loyalty rewards programs of their own.

In some aspects, the systems, methods, and computer program products of the present disclosure may allow a given enterprise to present one or more investment opportunities to a user upon the completion of a business transaction (such as a sale, purchase, or exchange). For example, upon completion of a purchase from an enterprise, a user may be presented with an opportunity to obtain one or more investments in the form of one or more shares of the enterprise's stock as a reward for doing business with the enterprise. By having an even relatively small ownership interest in the enterprise, the user may become incentivized to help the enterprise succeed and/or expand as doing so may increase the value of the user's investment. This may encourage the user to do business with the enterprise again in the future as well as recruit other users to do business with the enterprise, thereby serving as an effective marketing tool. Additionally, when the value of the enterprise's stock increases, any user(s) that hold shares of stock in the enterprise will likely view the enterprise more favorably since it will be helping them generate wealth, thereby helping the enterprise to obtain a more favorable public image.

In some aspects, user(s) may also be presented with one or more investment opportunities by connecting with, interacting with, interfacing with, and/or otherwise engaging with an enterprise via one or more online sites and/or one or more forms of social media, such as LinkedIn® (available from LinkedIn Corporation of Sunnyvale, Calif.), Facebook® (available from Facebook, Inc. of Menlo Park, Calif.) and/or Twitter® (available from Twitter Inc. of San Francisco, Calif.). For example, user(s) may receive an opportunity to obtain one or more shares of an enterprise's stock after spending a certain amount of time visiting the enterprise's website, blog, and/or social media network(s)/site(s)/page(s)/account(s) and/or visiting the enterprise's website, blog, and/or social media network(s)/site(s)/page(s)/account(s) with a certain frequency; after making a certain number of “clicks” (e.g., selections on a graphical user interface via one or more input devices associated with a computing device) on the enterprise's website, blog, and/or social media network(s)/site(s)/page(s)/account(s); after making a certain number of content uploads to the enterprise's website, blog, and/or social media network(s)/site(s)/page(s)/account(s); and/or upon having a certain number of interactions with the enterprise's website, blog, and/or social media network(s)/site(s)/page(s)/account(s) (e.g., having a certain number of “Likes,” “Retweets,” shares, posts, etc.). In some additional aspects, user(s) may be presented with one or more investment opportunities when one or more of their associates, such as friends, relatives, and/or acquaintances, complete a transaction with, connect with, interact with, interface with, and/or otherwise engage with a given enterprise, either in person or online.

In some aspects, any investment opportunity(ies) offered to a user via the systems, methods, and computer program products of the present disclosure may be distributed or delivered to the user's brokerage account electronically, especially when the investment opportunity(ies) may comprise one or more shares of stock. In some additional aspects, any fees associated with the use and/or management of such brokerage account, including trade fees and commission payments, may be covered by the enterprise and/or a third party.

In some aspects, a user may be required to meet at least one criterion in order to be eligible to receive an investment opportunity from an enterprise using the systems, methods, and computer program products of the present disclosure. For example, the user may be required to be a United States (U.S.) citizen or legal U.S. resident, be at least 18 years old, be a user of an enterprise's products and/or services for at least a year (or other amount of time), complete one or more surveys, etc.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating the distribution of one or more investment opportunities as consumer loyalty rewards to one or more users, according to an aspect of the present disclosure.

FIG. 2 is a flowchart illustrating an exemplary process for distributing one or more investment opportunities as consumer loyalty rewards to at least one user, according to an aspect of the present disclosure.

FIG. 3 is a flowchart illustrating an exemplary process for distributing one or more investment opportunities as consumer loyalty rewards to at least one user who meets at least one eligibility requirement, according to an aspect of the present disclosure.

FIG. 4 is a flowchart illustrating an exemplary process for distributing one or more investment opportunities to at least one user as a reward for interacting with an enterprise, according to an aspect of the present disclosure.

FIG. 5 is a flowchart illustrating an exemplary process for distributing one or more investment opportunities to at least one user who meets at least one eligibility requirement as a reward for interacting with an enterprise, according to an aspect of the present disclosure.

FIG. 6 is a is a flowchart illustrating an exemplary process for distributing one or more investment opportunities to at least one user upon receiving at least one enterprise interaction, according to an aspect of the present disclosure.

FIG. 7 is a flowchart illustrating an exemplary process for distributing one or more investment opportunities to at least one user who meets at least one eligibility requirement upon receiving at least one enterprise interaction, according to an aspect of the present disclosure.

FIG. 8 is a block diagram of an exemplary computing system useful for implementing one or more aspects of the present disclosure.

### DETAILED DESCRIPTION

The present disclosure is directed to systems, methods, and computer program products for facilitating the ability of one or more profit generating or nonprofit enterprises to increase consumer loyalty by offering users a chance to receive one or more investment opportunities as a reward for doing business with or otherwise dealing with a given enterprise and/or engaging with a particular enterprise via one or more websites (including, for example and not limitation, via one or more social media networks/sites/pages/accounts). By way of example and not limitation, an investment opportunity may comprise an opportunity to obtain an investment in the form of one or more shares of the enterprise's stock that may, in some aspects, be traded on a public stock exchange, such as, by way of example and not limitation, the New York Stock Exchange. By obtaining even a small ownership percentage of a given enterprise, a user may become incentivized to do business with that enterprise, both now and in the future, as well as encourage associates such as friends, relatives, and/or acquaintances to do business with the enterprise in order to increase the value of the user's stock and/or dividend payments that may be associated therewith. As will be appreciated by those skilled in the relevant art(s) after reading the description herein, in some aspects, a particular enterprise may offer one or more shares of stock of different enterprises to a user in order to encourage the user and/or the user's friends, relatives, and/or acquaintances to deal with certain targeted enterprises (e.g., partners, subsidiaries, etc.) and/or to otherwise enrich the user with increased wealth in order to help the enterprise offering the share(s) of stock gain a more favorable opinion in the mind of the user and/or the minds of the user's friends/relatives/acquaintances. In some additional aspects, an enterprise may even offer a user one or more shares of stock of a competing enterprise if doing so will enrich the user with increased wealth in order to help the enterprise offering the share(s) of stock gain a more favorable opinion in the mind of the user and/or the minds of the user's friends/relatives/acquaintances. In some nonlimiting exemplary embodiments, a user may be able to obtain as many shares of a given enterprise's stock as are available on a stock exchange and/or that may be approved by the enterprise, such as, by way of example and not limitation, as many shares as may be approved by the enterprise's board of directors.

In some aspects, a user may receive at least one investment opportunity as a reward for completing a business transaction, such as, by way of example and not limitation, a purchase of an enterprise's goods and/or services (including, for example and not limitation, paying to use or obtain a license to use an enterprise's software and/or computer application(s)). In some additional aspects, a user may receive one or more investment opportunities as a reward for interacting or interfacing with an enterprise via one or more online portals or sites, including but not limited to engaging with an enterprise's website, blog, and/or social media network(s), site(s), page(s), and/or account(s).

In some aspects, a user may be required to meet one or more criteria in order to be eligible to participate in an enterprise's investment based consumer loyalty rewards program and/or receive one or more investment opportunities associated therewith. By way of example and not limitation, such criteria may include various age restrictions, residency requirements, transaction history rules, membership restrictions, and the like.

The term “enterprise” and/or the plural form of this term are used throughout herein to refer to any individual or entity that may offer one or more goods and/or services to be obtained by, used by, and/or otherwise benefit one or members of the public, including software and/or one or more computer applications, either as a profit generating establishment or as a nonprofit organization, such as businesses, merchants, salesmen, service providers, airlines, credit card companies, retail stores, gyms, restaurants, religious organizations, clubs, groups, charitable organizations, and the like.

The term “user” and/or the plural form of this term are used throughout herein to refer to any individual or entity that may receive one or more goods and/or services from one or more of the enterprises defined above, such as individual consumers, business entity consumers, nonprofit organization consumers, club members, group members, visitors, sponsors, patrons, and the like.

The term “investment opportunity” and/or the plural form of this term are used throughout herein to refer to any opportunity to obtain at least partial ownership rights to one or more items that may be used to generate wealth, such as the opportunity to obtain one or more shares of stock of an enterprise that may be traded on a stock exchange (either currently available or available in the future, such as when the enterprise has an initial public offering (IPO)), the opportunity to obtain at least partial ownership of one or more parcels of land, the opportunity to obtain at least partial ownership of one or more real estate properties, the opportunity to obtain one or more bonds, the opportunity to obtain an amount of one or more precious metals (e.g., gold and/or silver), the opportunity to obtain an amount of one or more precious stones (e.g., diamonds), the opportunity to obtain one or more rare items and/or antique items, and the like.

The term “investment” and/or the plural form of this term are used throughout herein to refer to any at least partial ownership rights to one or more items that may be used to generate wealth, such as one or more shares of stock of an enterprise that may be traded on a stock exchange (either currently available or available in the future, such as when the enterprise has an initial public offering (IPO)), at least partial ownership of one or more parcels of land, at least partial ownership of one or more real estate properties, one or more bonds, an amount of one or more precious metals (e.g., gold and/or silver), an amount of one or more precious stones (e.g., diamonds), one or more rare items and/or antique items, and the like.

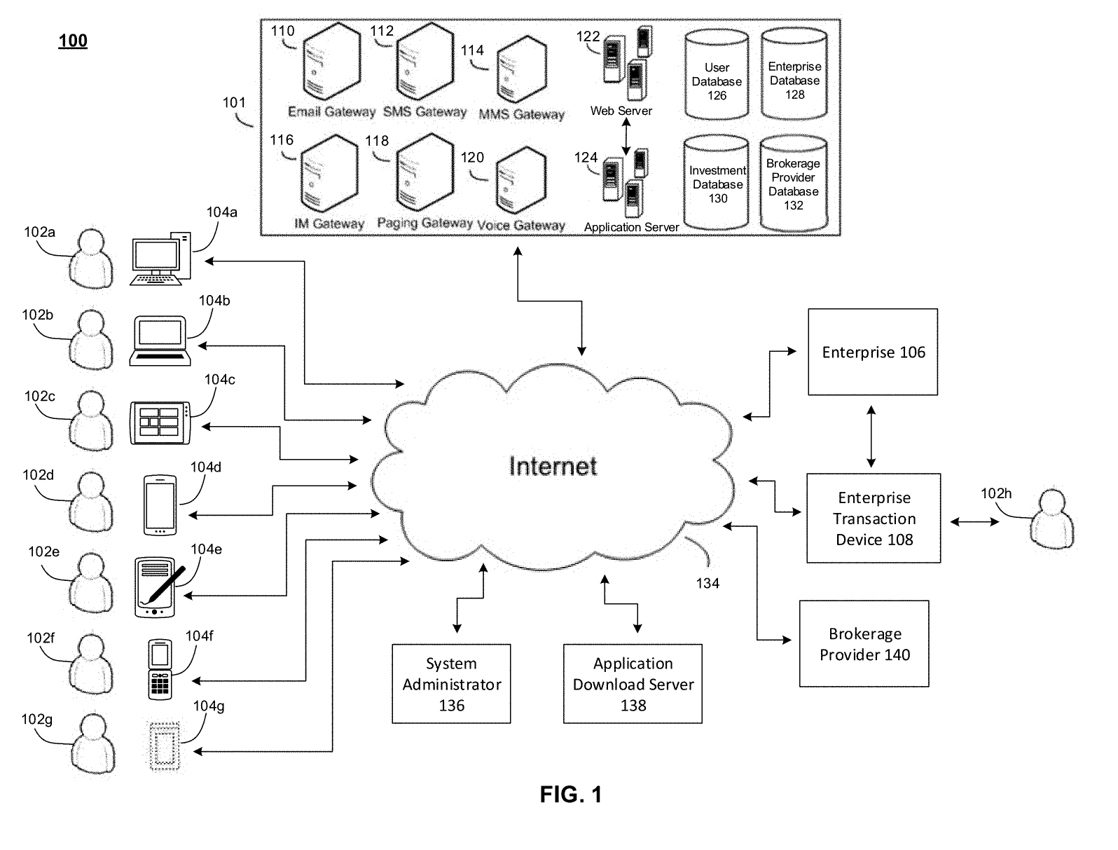

Referring now to FIG. 1, a block diagram of an exemplary system 100 for facilitating the distribution of one or more investment opportunities as consumer loyalty rewards to one or more users 102, according to an aspect of the present disclosure, is shown.

Cloud-based, Internet-enabled device communication system 100 may include a plurality of users 102 (shown as users 102a-g in FIG. 1) accessing, via a computing device 104 (shown as respective computing devices 104a-g in FIG. 1) and a network 134, such as the global, public Internet an application service provider's cloud-based, Internet-enabled infrastructure 101. In some aspects, a user application may be downloaded onto computing device 104 from an application download server 138. Application download server 138 may be a public application store service or a private download service or link. Computing device 104 may access application download server 138 via network 134. In another nonlimiting embodiment, infrastructure 101 may be accessed via a website or web application. Multiple users 102 may, simultaneously or at different times, access (via, for example, a user application) infrastructure 101 in order to engage in communication with other users 102, enterprise 106, and/or brokerage provider 140 or to access user database 126, enterprise database 128, investment database 130, and/or brokerage provider database 132.

In an embodiment, a user 102 may communicate with an enterprise 106 via computing device 104 in order to complete purchases; complete sales; complete a product exchange; exchange information; purchase, access, and/or use software and/or computer application(s); access and/or use one or more websites, blogs, and/or social media networks/sites/pages/accounts and/or engage, interact, or interface therewith; obtain one or more investment opportunities and/or receive one or more investments; as well as for similar purposes as may be apparent to those skilled in the relevant art(s) after reading the description herein. In some additional nonlimiting embodiments, a user 102h may communicate directly with enterprise 106 using at least one input device (such as mouse, keyboard, touchscreen, joystick, microphone, camera, scanner, chip reader, card reader, magnetic stripe reader, near field communication technology, and the like) associated with an enterprise transaction device 108. By way of example and not limitation, enterprise transaction device 108 may comprise a payment terminal, computer kiosk, scanning device, or any similar device or system as may be apparent to those skilled in the relevant art(s) after reading the description herein. In still some additional aspects, enterprise transaction device 108 may be used to perform any of the tasks that may be performed using computing device 104.

In aspects wherein one or more investments obtained by user 102 may comprise one or more electronically or digitally receivable shares of stock, user 102 may use computing device 104 and/or enterprise transaction device 108 to communicate with at least one brokerage provider 140. In some nonlimiting exemplary embodiments, brokerage provider 140 may comprise any individual, firm, or entity whose main responsibility is to serve as an intermediary that puts buyers and sellers together in order to facilitate a transaction, often in exchange for a fee or commission payment. Brokerage provider 140 may, by way of example and not limitation, facilitate the delivery of one or more shares of stock to an electronic user 102 brokerage account. In some aspects, any fees and/or commissions charged by brokerage provider 140 may be paid for by enterprise 106 and/or a third party. Examples of brokerage providers may include, without limitation, E-Trade Financial Corporation of New York, N.Y.; the Charles Schwab Corporation of San Francisco, Calif.; Scottrade® (available from Scottrade Financial Services, Inc. of St. Louis, Mo.); RE/MAX, LLC of Denver, Colo.; and the like. Users 102 may be able to create one or more brokerage accounts with one or more brokerage providers 140 in order to execute one or more investment transactions associated with enterprise 106 or similar entities, including, by way of example and not limitation, obtaining and/or selling one or more shares of stock, parcels of land, real estate properties, bonds, precious metals, precious stones, and/or rare items and/or antiques, by communication via Internet 134 using various computing devices 104 and/or enterprise transaction device 108. In some aspects, a user 102 may only be allowed to use one brokerage account to receive investment(s) from enterprise 106. In some additional aspects, multiple users 102 may not be allowed to share a single brokerage account.

In various aspects, computing device 104 may be configured as: a desktop computer 104a, a laptop computer 104b, a tablet or mobile computer 104c, a smartphone (alternatively referred to as a mobile device) 104d, a Personal Digital Assistant (PDA) 104e, a mobile phone 104f, a handheld scanner 104g, any commercially-available intelligent communications device, or the like.

As shown in FIG. 1, in an aspect of the present disclosure, an application service provider's cloud-based, communications infrastructure 101 may include an email gateway 110, an SMS (Short Message Service) gateway 112, an MMS (Multimedia Messaging Service) gateway 114, an Instant Message (IM) gateway 116, a paging gateway 118, a voice gateway 120, one or more web servers 122, one or more application servers 124, a user database 126, an enterprise database 128, an investment database 130, and a brokerage provider database 132. Application server(s) 124 may contain computational instructions, or code, that enables the functionality of system 100. User database 126, enterprise database 128, investment database 130, and/or brokerage provider database 132 may not necessarily be contained within infrastructure 101, such as, but not limited to, user database 126, enterprise database 128, investment database 130, and/or brokerage provider database 132 may be supplied by a third party. As will be apparent to those skilled in the relevant art(s) after reading the description herein, communications infrastructure 101 may include one or more additional storage, communications, and/or processing components to facilitate communication within system 100, process data, store content, and the like.

User database 126 may be configured to store information pertaining to one or more users 102. In an aspect, a user 102 may comprise an individual or entity that may receive one or more goods, services, and/or other benefits from one or more enterprises 106 by being a consumer, customer, patron, visitor, member, and/or sponsor thereof and/or by having any similar relationship with one or more enterprises 106 as may be apparent to those skilled in the relevant art(s) after reading the description herein. User 102 information that may be stored within user database 126 may include, by way of example and not limitation, a given user's 102 name, type (e.g., whether user 102 is individual, business entity, nonprofit organization, club member, group member, visitor, sponsor, etc.), account or profile information (e.g., payment information, transaction account balances, etc.), age, citizenship, residency, membership affiliations, list of investment opportunities offered, list of investments obtained, enterprise 106 transaction or interaction history (e.g., purchases, website visits, social media responses/interactions/reactions/interfaces, etc.), infrastructure 101 usage history, login credentials (including passwords, usernames, passcodes, pin numbers, fingerprint scan data, retinal scan data, voice authentication data, and the like), and the like.

Enterprise database 128 may be configured to store information pertaining to one or more enterprises 106. In an aspect, an enterprise 106 may comprise any individual or entity that offers one or more goods and/or services to be obtained and/or used by one or more members of the public, including software and/or one or more computer application(s), either as a profit generating establishment or as a nonprofit organization. By way of example and not limitation, enterprise 106 may comprise a business, a merchant, a salesman, a service provider, an airline, a credit card company, a retail store, a gym, a restaurant, a religious organization, a club, a group, a charitable organization, and the like. Enterprise 106 information that may be stored within enterprise database 128 may include, by way of example and not limitation, a given enterprise's 106 name, type (e.g., whether it is a business, merchant, salesman, service provider, airline, credit card company, retail store, restaurant, gym, religious organization, club, group, charitable organization, etc.), account or profile information, list of investment opportunities available, list of investments distributed or delivered, infrastructure 101 usage history, login credentials (including passwords, usernames, passcodes, pin numbers, fingerprint scan data, retinal scan data, voice authentication data, and the like), user/customer/member/sponsor/visitor rank/rating, and the like.

Investment database 130 may be configured to store information about one or more investment opportunities currently available and/or one or more investments previously distributed or delivered to one or more users 102. Such information may include, by way of example and not limitation, what type(s) of investment opportunities are available and/or what type of investments have been distributed/delivered (e.g., shares of stock, bonds, parcels of land, real estate properties, precious metals, precious stones, rare items and/or antiques, etc.), how many investment opportunities are currently available and/or how many investments have been distributed/delivered, financial information regarding investment opportunities that are currently available and/or regarding investments that have been previously distributed/delivered (e.g., price history and forecast analysis, market trend information, financial indicators, etc.), how currently available investment opportunities may be obtained and/or how previously distributed/delivered investments were obtained (e.g., by purchasing a certain item or amount of merchandise, by purchasing certain services, by paying to use software and/or one or more computer applications or purchasing a license for such software and/or application(s), by visiting a website, blog, or social media network/site/page/account a certain number of times and/or for a certain amount of time, by interacting with one or more social media networks/sites/pages/accounts (e.g., giving a certain number of “Likes” on an enterprise's 106 Facebook® (available from Facebook, Inc. of Menlo Park, Calif.) page), etc.), and the like.

Brokerage provider database 132 may be configured to store information about one or more brokerage providers 140 that may be required or desired to facilitate transactions between one or more users 102 and one or more enterprises 106 regarding one or more investment opportunities and/or investments. In some aspects wherein the investment opportunity(ies) offered to a user 102 by enterprise 106 may comprise the receipt of at least one share of an enterprise's 106 stock, for example and not limitation, a brokerage provider 140 in the form of, for example and not limitation, a stockbroker, may be required in order to distribute the share(s) to the user's 102 brokerage account on behalf of enterprise 106. User 102 may obtain as many shares of stock as are available and/or that may be approved by enterprise 106, such as may be approved by enterprise's 106 board of directors. In some additional aspects wherein the investment opportunity(ies) offered to user 102 may comprise the obtaining of at least partial ownership of one or more parcels of land or the obtaining of at least partial ownership of one or more real estate properties, for further example and not limitation, a brokerage provider 140 in the form of, for example and not limitation, a real estate broker, may be desired to facilitate the transaction between user 102 and enterprise 106. Brokerage provider 140 information that may be stored within brokerage provider database 132 may include, by way of example and not limitation, a given brokerage provider's 140 name, contact information, type (e.g., stockbroker, real estate broker, etc.), user/consumer rank/rating, fee or commission schedule, list of user 102 accounts associated therewith (as well as relevant account information), and the like.

In alternate aspects, user database 126, enterprise database 128, investment database 130, or brokerage provider database 132 may comprise one or more data stores within (or remotely located from) infrastructure 101 or be memory included in (or coupled to) web server 122.

User database 126, enterprise database 128, investment database 130, and brokerage provider database 132 may each be physically separate from one another, logically separate, or physically or logically indistinguishable from some or all other databases.

A system administrator 136 may access infrastructure 101 via the Internet 134 in order to oversee and manage infrastructure 101.

As will be appreciated by those skilled in the relevant art(s) after reading the description herein, an application service provider an individual person, business, or other entity may allow access, on a free registration, paid subscriber, and/or pay-per-use basis, to infrastructure 101 via one or more World-Wide Web (WWW) sites on the Internet 134. Thus, system 100 is scalable.

As will also be appreciated by those skilled in the relevant art(s), in an aspect, various screens may be generated by server 122 in response to input from users 102 over Internet 134. As a nonlimiting example, server 122 may comprise a typical web server running a server application at a website which sends out webpages in response to Hypertext Transfer Protocol (HTTP) or Hypertext Transfer Protocol Secured (HTTPS) requests from remote browsers on various computing devices 104 being used by various users 102. Thus, server 122 is able to provide a graphical user interface (GUI) to users 102 that utilize system 100 in the form of webpages. These webpages are sent to the user's 102 PC, laptop, mobile device, PDA, or like device 104, and would result in the GUI being displayed.

As will be appreciated by those skilled in the relevant art(s) after reading the description herein, alternate aspects of the present disclosure may include providing a tool for facilitating the distribution of investment opportunities and/or investments associated with enterprise(s) 106 to user(s) 102 via computing device(s) 104 and/or enterprise transaction device 108 as a stand-alone system (e.g., installed on one server PC) or as an enterprise system wherein all the components of system 100 are connected and communicate via an inter-corporate Wide Area Network (WAN) or Local Area Network (LAN). For example, in an aspect where users 102 are all personnel/employees of the same company or are all members of the same group, the present disclosure may be implemented as a stand-alone system, rather than as a web service (i.e., Application Service Provider (ASP) model utilized by various unassociated/unaffiliated users) as shown in FIG. 1.

As will also be appreciated by those skilled in the relevant art(s) after reading the description herein, alternate aspects of the present disclosure may include providing the tools for facilitating the distribution of investment opportunities and/or investments associated with enterprise(s) 106 to user(s) 102 via infrastructure 101, computing device(s) 104, and/or enterprise transaction device 108 via a browser or operating system pre-installed with an application or a browser or operating system with a separately downloaded application on such computing device(s) 104 and/or enterprise transaction device 108. That is, as will also be apparent to those skilled in the relevant art(s) after reading the description herein, the application that facilitates the distribution of investment opportunities and/or investments associated with enterprise(s) 106 to user(s) 102 may be part of the “standard” browser or operating system that ships with computing device 104 or enterprise transaction device 108 or may be later added to an existing browser or operating system as part of an “add-on,” “plug-in,” or “app store download.”

Communication infrastructure 101 may be encrypted to provide for secure communications A security layer may be included that is configurable using a non-hard-cooled technique selectable by user 102, enterprise 106, and/or brokerage provider 140 which may be based on at least one of: user 102, enterprise 106, brokerage provider 140, country encryption standards, etc. A type of encryption may include, but is not limited to, protection at least at one communication protocol layer such as the physical hardware layer, communication layer (e.g., radio), data layer, software layer, etc. Encryption may include human interaction and confirmation with built-in and selectable security options, such as, but not limited to, encoding, encrypting, hashing, layering, obscuring, password protecting, and obfuscation of data transmission, frequency hopping and various combinations thereof. As a nonlimiting example, the prevention of spoofing and/or eavesdropping may be accomplished by adding two-prong security communication and confirmation using two or more data communication methods (e.g., light and radio) and protocols (e.g., pattern and freq. hopping). Thus, at least one area of security, as provided above, may be applied to at least provide for communication being encrypted while in the cloud, communication with user 102, communication with enterprise 106, communication with enterprise transaction device 108, and/or communication with brokerage provider 140 that may occur via the Internet 134, a Wi-Fi connection, Bluetooth® (a wireless technology standard standardized as IEEE 802.15.1), satellite, or another communication link, communications between computing device(s) 104 and enterprise 106, communications between computing device(s) 104 and brokerage provider 140, communications between enterprise 106 and brokerage provider 140, communications between enterprise transaction device 108 and enterprise 106, communications between computing device(s) 104 and enterprise transaction device 108, communications between Internet of Things devices and enterprise 106, brokerage provider 140, and/or enterprise transaction device 108, and the like.

The Internet of Things, also known as IoT, is a network of physical objects or “things” embedded with electronics, software, sensors, and connectivity to enable objects to exchange data with the manufacturer, operator, and/or other connected devices based on the infrastructure of International Telecommunication Union's Global Standards Initiative. The Internet of Things allows objects to be sensed and controlled remotely across existing network infrastructure, creating opportunities for more direct integration between the physical world and computer-based systems, and resulting in improved efficiency, accuracy, and economic benefit. Each thing is uniquely identifiable through its embedded computing system but is able to interoperate within the existing Internet infrastructure. Communications may comprise use of transport layer security (“TLS”), fast simplex link (“FSL”), data distribution service (“DDS”), hardware boot security, device firewall, application security to harden from malicious attacks, self-healing/patching/firmware upgradability, and the like. Security may be further included by use of at least one of: obfuscation of data transmission, hashing, cryptography, PKI, secured boot access, and the like.

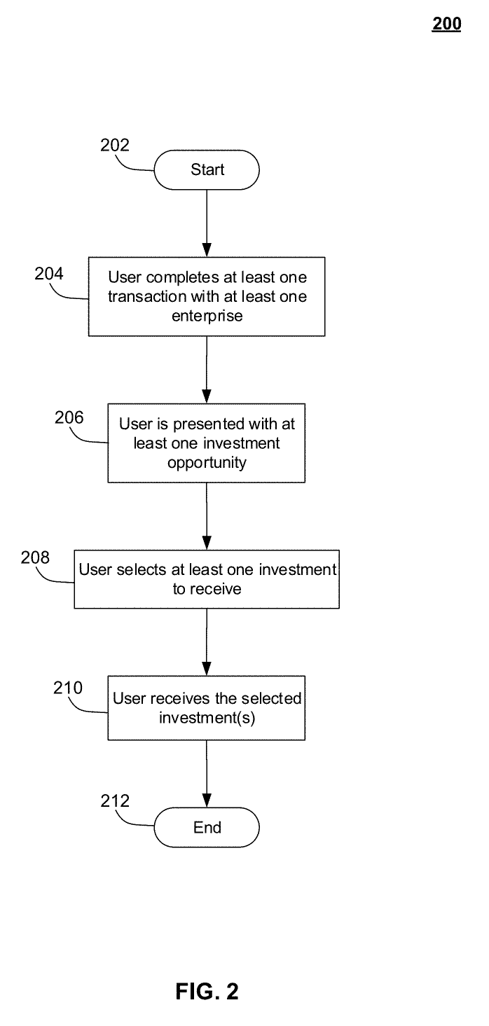

Referring now to FIG. 2, a flowchart illustrating an exemplary process 200 for distributing one or more investment opportunities as consumer loyalty rewards to at least one user 102, according to an aspect of the present disclosure, is shown.

Process 200, which may at least partially execute within system 100 (not shown in FIG. 2), begins at step 202 with control passing immediately to step 204.

At step 204, user 102 (not shown in FIG. 2) completes at least one transaction with at least one enterprise 106 (not shown in FIG. 2). By way of example and not limitation, the transaction(s) may comprise a purchase, sale, exchange, gift, donation, or similar dealing as may be apparent to those skilled in the relevant art(s) after reading the description herein. The transaction may, in some nonlimiting embodiments, be for the receipt or distribution of goods and/or services, including the right to access, use, and/or obtain a license for one or more software programs, computer applications, online accounts, websites, applications, and/or networks (including social media networks). In some aspects, the transaction(s) may be completed utilizing at least one enterprise transaction device 108 (not shown in FIG. 2). By way of example and not limitation, enterprise transaction device 108 may comprise a payment terminal, computer kiosk, scanning device, or any similar device or system as may be apparent to those skilled in the relevant art(s) after reading the description herein.

At step 206, user 102 is presented with at least one investment opportunity which may, in some aspects, be obtained for little or no cost to user 102 as a reward for completing at least one transaction with at least one enterprise 106. By way of example and not limitation, in some aspects, the at least one investment opportunity may be presented via a graphical user interface associated with enterprise transaction device 108, or the at least one investment opportunity may be manually provided by one or more representatives of enterprise 106, such as verbally and/or by presenting user 102 with one or more written offers. By way of further example and not limitation, the at least one investment opportunity may comprise the opportunity to obtain one or more shares of stock (including one or more shares of stock that may be associated with enterprise 106), the opportunity to obtain at least partial ownership of one or more parcels of land, the opportunity to obtain at least partial ownership of one or more real estate properties, the opportunity to obtain one or more bonds, the opportunity to obtain one or more precious metals, the opportunity to obtain one or more precious stones, the opportunity to obtain one or more rare items and/or antiques, as well as any similar investment opportunities that may be used to generate wealth as may be apparent to those skilled in the relevant art(s) after reading the description herein.

At step 208, user 102 selects at least one investment to receive. By way of example and not limitation, the selection may be indicated by verbally communicating it to one or more representatives of enterprise 106; by using a pen, pencil, or other writing utensil to mark a written or typed offer sheet or ballot; by clicking on or otherwise selecting one or more desired investment opportunities or by clicking on or otherwise selecting one or more check boxes or radio buttons associated with one or more desired investment opportunities via a graphical user interface associated with enterprise transaction device 108 and/or by using one or more input devices, such as a mouse, keyboard, touchscreen, joystick, microphone, camera, and the like, that may be associated with enterprise transaction device 108 to select the desired investment opportunity(ies) and/or check box(es) or radio button(s) associated therewith; or by any similar appropriate means as may be apparent to those skilled in the relevant art(s) after reading the description herein.

In order to make a more informed decision, in some aspects, user 102 may obtain more information regarding one or more investment opportunities before making a selection. By way of example and not limitation, this information may be obtained by consulting one or more representatives of enterprise 106, by obtaining one or more documents from enterprise 106 for review, by consulting one or more online resources (such as, by way of example and not limitation, the Google® search engine (available from Google Inc. of Mountain View, Calif.), or by any similar appropriate means as may be apparent to those skilled in the relevant art(s) after reading the description herein. By way of further example and not limitation, this information may be obtained by clicking on or otherwise selecting one or more investment opportunities for which more information is desired or by clicking on or otherwise selecting one or more check boxes or radio buttons associated with one or more investment opportunities for which more information is desired via a graphical user interface associated with enterprise transaction device 108 and/or by using one or more input devices, such as a mouse, keyboard, touchscreen, joystick, microphone, camera, and the like, that may be associated with enterprise transaction device 108 to select one or more investment opportunities for which more information may be desired (or one or more check boxes or radio buttons associated therewith) in order to be presented with the additional desired information, or by using a mouse or other pointer device to “hover” over one or more investment opportunities for which more information is desired until a pop-up notification, hover box, and/or sound is presented via a graphical user interface associated with enterprise transaction device 108 that delivers the desired additional information. In some aspects, information regarding one or more investment opportunities may comprise price history, forecast analysis, market trend information, and/or financial indicators, as well as similar information as may be apparent to those skilled in the relevant art(s) after reading the description herein. By way of still further example and not limitation, in some nonlimiting exemplary embodiments, information regarding one or more investment opportunities may be previously stored within and later retrieved form investment database 130 (not shown in FIG. 2) and/or retrieved from Internet 134 (not shown in FIG. 2).

At step 210, user 102 receives the selected investment(s), which may be delivered via any appropriate means as may be apparent to those skilled in the relevant art(s) after reading the description herein. By way of example and not limitation, in aspects wherein the investment(s) may comprise the receipt of one or more shares of stock, user 102 may provide enterprise 106 with any necessary brokerage account information needed to distribute or deliver the share(s) to one or more brokerage accounts associated with user 102 (or this information may be previously uploaded to and stored in and retrieved from, as a nonlimiting example, user database 126 (not shown in FIG. 2)). In some aspects, this distribution or delivery may be done electronically such as, by way of example and not limitation, via enterprise transaction device 108. In some additional aspects, any costs or fees that may be associated with the distribution or the delivery of the investment(s) to user 102, including the cost of the investment(s) itself, may be paid for or waived by enterprise 106 or a third party, thereby allowing user 102 to receive the investment(s) at little or no cost. User 102 may provide other required information needed to obtain other types of investment(s) as necessary, such as, by way of example and not limitation, an address or meeting location, or such information may be previously uploaded to and stored in and retrieved from, as a nonlimiting example, user database 126.

At step 212 process 200 is terminated and process 200 ends.

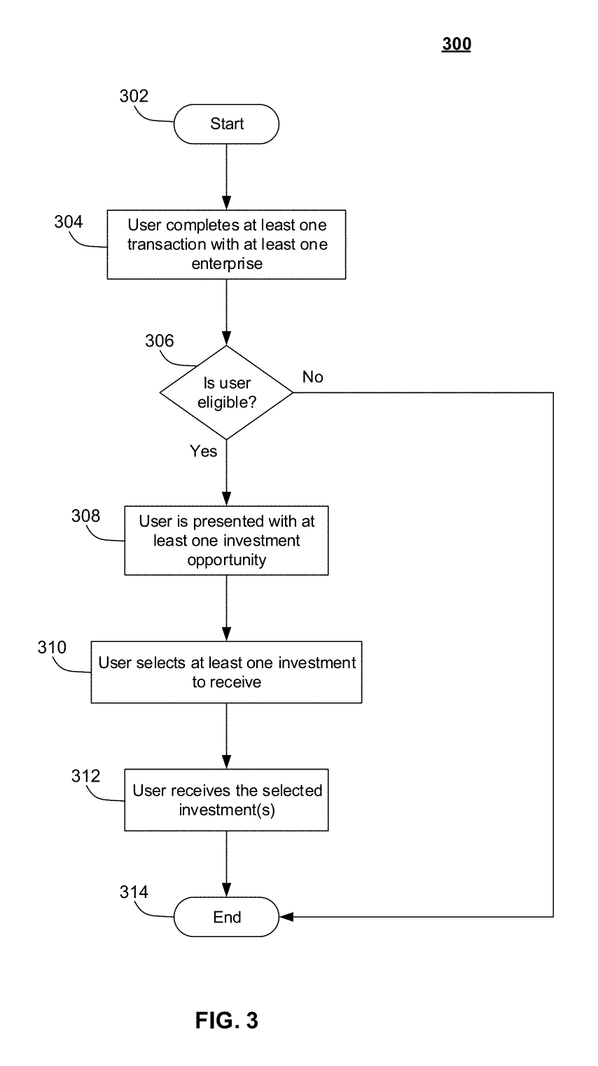

Referring now to FIG. 3, a flowchart illustrating an exemplary process 300 for distributing one or more investment opportunities as consumer loyalty rewards to at least one user 102 who meets at least one eligibility requirement, according to an aspect of the present disclosure, is shown.

Process 300, which may at least partially execute within system 100 (not shown in FIG. 3), begins at step 302 with control passing immediately to step 304.

At step 304, user 102 (not shown in FIG. 3) completes at least one transaction with at least one enterprise 106 (not shown in FIG. 3). By way of example and not limitation, the transaction(s) may comprise a purchase, sale, exchange, gift, donation, or similar dealing as may be apparent to those skilled in the relevant art(s) after reading the description herein. The transaction may, in some nonlimiting embodiments, be for the receipt or distribution of goods and/or services, including the right to access, use, and/or obtain a license for one or more software programs, computer applications, online accounts, websites, applications, and/or networks (including social media networks). In some aspects, the transaction(s) may be completed utilizing at least one enterprise transaction device 108 (not shown in FIG. 3). By way of example and not limitation, enterprise transaction device 108 may comprise a payment terminal, computer kiosk, scanning device, or any similar device or system as may be apparent to those skilled in the relevant art(s) after reading the description herein.

At step 306, it is determined whether user 102 is eligible to receive one or more investments from at least one enterprise 106. Such determination may be made at least partially based on whether user 102 meets one or more certain criteria. By way of example and not limitation, criteria that may have to be met by user 102 in order to receive investment(s) from enterprise 106 may include: being a U.S. citizen or legal U.S. resident; being at least 18 years old at the time of receiving the investment(s); being a consumer, customer, patron, visitor, member, sponsor, and/or having a similar relationship with enterprise 106 and/or having at least one previous interaction with enterprise 106 during at least a year before receiving any investment(s) therefrom; having not received any investment(s) from enterprise 106 previously; completing at least one survey providing one or more opinions, loyalties, recommendations, experiences, interactions, likes, dislikes, ratings, reactions, or other feedback to enterprise 106; providing at least one form of legally accepted photo identification at the time the investment(s) may be received; having at least one brokerage account in the U.S.; being a registered and/or active member of a membership group associated with enterprise 106 (and, in some aspects, being a member of the group for a certain amount of time); having a certain number of associates such as friends, relatives, and/or acquaintances be registered and/or active members of a membership group associated with enterprise 106 (and, in some aspects, having them be members of the group for a certain amount of time); as well as any similar appropriate criteria as may be apparent to those skilled in the relevant art(s) after reading the description herein. In some aspects wherein user 102 may be between 13 and 18 years old, a parent or legal guardian may provide authorization for that user 102 to receive one or more investment(s) offered by enterprise 106 or such users 102 may wait until they are 18 years old to obtain their investment(s). In some additional nonlimiting exemplary embodiments, the determination of whether user 102 is eligible to receive investment(s) from enterprise 106 may be at least partially determined by retrieving data previously uploaded to and stored in, by way of example and not limitation, user database 126 (not shown in FIG. 3) and comparting it against a list of requirements, either manually or via a computing device, such as, for example and not limitation, via enterprise transaction device 108 and/or computing device 104.

If the determination is in the affirmative, process 300 proceeds to step 308; if the determination is negative, process 300 proceeds to step 314.

At step 308, user 102 is presented with at least one investment opportunity which may, in some aspects, be obtained for little or no cost to user 102 as a reward for completing at least one transaction with at least one enterprise 106. By way of example and not limitation, in some aspects, the at least one investment opportunity may be presented via a graphical user interface associated with enterprise transaction device 108, or the at least one investment opportunity may be manually provided by one or more representatives of enterprise 106, such as verbally and/or by presenting user 102 with one or more written offers. By way of further example and not limitation, the at least one investment opportunity may comprise the opportunity to obtain one or more shares of stock, the opportunity to obtain at least partial ownership of one or more parcels of land, the opportunity to obtain at least partial ownership of one or more real estate properties, the opportunity to obtain one or more bonds, the opportunity to obtain one or more precious metals, the opportunity to obtain one or more precious stones, the opportunity to obtain one or more rare items and/or antiques, as well as any similar investment opportunities that may be used to generate wealth as may be apparent to those skilled in the relevant art(s) after reading the description herein.

At step 310, user 102 selects at least one investment to receive. By way of example and not limitation, the selection may be indicated by verbally communicating it to one or more representatives of enterprise 106; by using a pen, pencil, or other writing utensil to mark a written or typed offer sheet or ballot; by clicking on or otherwise selecting one or more desired investment opportunities or by clicking on or otherwise selecting one or more check boxes or radio buttons associated with one or more desired investment opportunities via a graphical user interface associated with enterprise transaction device 108 and/or by using one or more input devices, such as a mouse, keyboard, touchscreen, joystick, microphone, camera, and the like, that may be associated with enterprise transaction device 108 in order to select the desired investment opportunity(ies) and/or check box(es) or radio button(s) associated therewith; or by any similar appropriate means as may be apparent to those skilled in the relevant art(s) after reading the description herein.

In order to make a more informed decision, in some aspects, user 102 may obtain more information regarding one or more investment opportunities before making a selection. By way of example and not limitation, this information may be obtained by consulting one or more representatives of enterprise 106, by obtaining one or more documents from enterprise 106 for review, by consulting one or more online resources (such as, by way of example and not limitation, the Google® search engine (available from Google Inc. of Mountain View, Calif.), or by any similar appropriate means as may be apparent to those skilled in the relevant art(s) after reading the description herein. By way of further example and not limitation, this information may be obtained by clicking on or otherwise selecting one or more investment opportunities for which more information is desired or by clicking on or otherwise selecting one or more check boxes or radio buttons associated with one or more investment opportunities for which more information is desired via a graphical user interface associated with enterprise transaction device 108 and/or by using one or more input devices, such as a mouse, keyboard, touchscreen, joystick, microphone, camera, and the like, that may be associated with enterprise transaction device 108 to select one or more investment opportunities for which more information is desired (or one or more check boxes or radio buttons associated therewith) in order to be presented with the additional desired information, or by using a mouse or other pointer device to “hover” over one or more investment opportunities for which more information is desired until a pop-up notification, hover box, and/or sound is presented via a graphical user interface associated with enterprise transaction device 108 that delivers the desired additional information. In some aspects, information regarding one or more investment opportunities may comprise price history, forecast analysis, market trend information, and/or financial indicators, as well as similar information as may be apparent to those skilled in the relevant art(s) after reading the description herein. By way of still further example and not limitation, in some nonlimiting exemplary embodiments, information regarding one or more investment opportunities may be previously stored within and later retrieved form investment database 130 (not shown in FIG. 3) and/or retrieved from Internet 134 (not shown in FIG. 3).

At step 312, user 102 receives the selected investment(s), which may be delivered via any appropriate means as may be apparent to those skilled in the relevant art(s) after reading the description herein. By way of example and not limitation, in aspects wherein the investment(s) may comprise the receipt of one or more shares of stock, user 102 may provide enterprise 106 with any necessary brokerage account information needed to distribute or deliver the share(s) to one or more brokerage accounts associated with user 102 (or this information may be previously uploaded to and stored in and retrieved from, as a nonlimiting example, user database 126). In some aspects, this distribution or delivery may be done electronically such as, by way of example and not limitation, via enterprise transaction device 108. In some additional aspects, any costs or fees that may be associated with the distribution or the delivery of the investment(s) to user 102, including the cost of the investment(s) itself, may be paid for or waived by enterprise 106 or a third party, thereby allowing user 102 to receive the investment(s) at little or no cost. User 102 may provide other required information needed to obtain other types of investment(s) as necessary, such as, by way of example and not limitation, an address or meeting location, or such information may be previously uploaded to and stored in and retrieved from, as a nonlimiting example, user database 126.

At step 314 process 300 is terminated and process 300 ends.

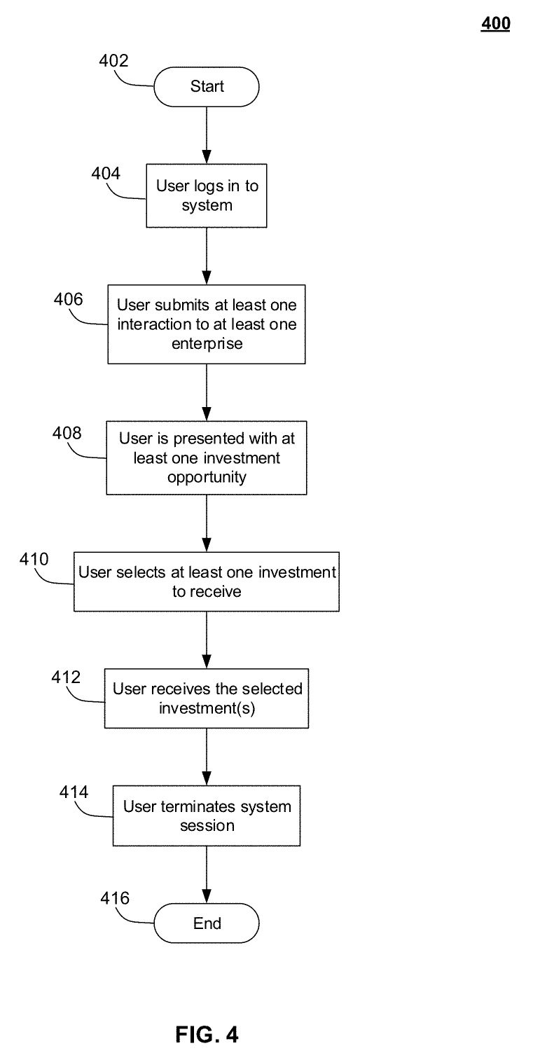

Referring now to FIG. 4, a flowchart illustrating an exemplary process 400 for distributing one or more investment opportunities to at least one user 102 as a reward for interacting with an enterprise 106, according to an aspect of the present disclosure, is shown.

Process 400, which may at least partially execute within system 100 (not shown in FIG. 4), begins at step 402 with control passing immediately to step 404.

At step 404, a user 102 (not shown in FIG. 4) logs in to system 100 via a computing device 104 (not shown in FIG. 4). In some aspects, user 102 or computing device 104 may provide login credentials, thereby allowing access to an account or profile associated with user 102. By way of example and not limitation, the login credentials may take place via a software application, a website, a web application, or the like accessed by computing device 104. By way of further example and not limitation, login credentials may comprise a username, password, passcode, key code, pin number, visual identification, fingerprint scan, retinal scan, voice authentication, and/or any similar identifying and/or security elements as may be apparent to those skilled in the relevant art(s) after reading the description herein as being able to securely determine the identity of user 102. In some aspects, user 102 may login using a login service such as a social media login service, an identity/credential provider service, a single sign on service, and the like. In various aspects, users 102 may create user 102 accounts/profiles via such login services. Any user 102 accounts/profiles may, in some aspects, be stored within and retrieved from user database 126 (not shown in FIG. 4). Once user 102 has successfully logged in to system 100, process 400 proceeds to step 406.

At step 406, user 102 submits at least one type of interaction to at least one enterprise 106 (not shown in FIG. 4). In some aspects, the interaction may comprise a transaction in the form of, for example and not limitation, a purchase, sale, exchange, gift, donation, and/or similar dealing. The transaction may take place in person, such as at a physical store, restaurant, gym, church, or similar location; or, the transaction may take place via one or more online means utilizing system 100, such as via a website displayed upon a graphical user interface associated with computing device 104 configured to receive one or more inputs from user 102 via at least one input device, such as a keyboard, touchscreen, mouse, joystick, microphone, camera, and the like.

In some additional aspects, the at least one interaction with enterprise 106 may comprise at least one type of engagement with a website, blog, social media network/site/page/account, or similar online portal or site associated with enterprise 106 using computing device 104 and/or one or more input devices that may be associated therewith, such as a mouse, keyboard, touchscreen, joystick, microphone, camera, and the like. By way of example and not limitation, such engagement may comprise user 102 visiting a website, blog, and/or social media network/site/page/account of enterprise 106; “liking,” commenting, posting, reposting, private messaging, video chatting, tagging, sharing, “friending” (sending or receiving a friend request and/or friend confirmation), or otherwise interacting or interfacing with enterprise 106 and/or content posted thereby on a Facebook® (available from Facebook, Inc. of Menlo Park, Calif.) page associated with enterprise 106; “tweeting,” “retweeting,” “liking,” “following,” direct messaging, or otherwise interacting or interfacing with enterprise 106 and/or content posted thereby on a Twitter® (available from Twitter Inc. of San Francisco, Calif.) account associated with enterprise 106; connecting with, viewing, messaging, or otherwise interacting or interfacing with content available on a LinkedIn® (available from LinkedIn Corporation of Sunnyvale, Calif.) account associated with enterprise 106; and/or otherwise engaging with any of a variety of similar social media accounts associated with enterprise 106, including but not limited to Instagram® (available from Instagram, LLC of San Francisco, Calif.), Snapchat® (available from Snapchat, Inc. of Los Angeles, Calif.), and similar social media networks or services as may be apparent to those skilled in the relevant art(s) after reading the description herein. By way of further example and not limitation, online engagement with enterprise 106 may comprise several other types of interaction, such as user 102 making one or more “clicks” (e.g., selections on a graphical user interface via one or more input devices associated with computing device 104) on content available on a website, blog, or social media network/site/page/account associated with enterprise 106 utilizing one or more input devices, such as a keyboard, touchscreen, mouse, joystick, microphone, camera, that may be associated with computing device 104; spending a certain amount of time visiting a website, blog, and/or social media network/site/page/account associated with enterprise 106 and/or visiting such websites, blogs, and/or social media networks/sites/pages/accounts with a certain frequency; inviting other users 102 to “friend,” “follow,” “like,” “join,” or otherwise connect with enterprise 106 on one or more social media networks/sites/pages/accounts, blogs, and/or websites associated therewith and/or receiving one or more such invitations; and/or uploading content to a website, blog, and/or social media network/site/page/account associated with enterprise 106. In some additional nonlimiting exemplary embodiments, user 102 may be credited with an interaction with enterprise 106 (or an at least partial interaction) when one or more associates such as friends, relatives, and/or acquaintances of user 102 interact with enterprise 106 on one or more websites, blogs, social media networks/sites/pages/accounts, and/or other online portals or sites (such associates may be verified, in some aspects, by way of example and not limitation, by data within a social media network associated with user 102).

In still some additional aspects, the at least one interaction user 102 may have with enterprise 106 may comprise purchasing and/or using software and/or one or more computer application(s) offered by enterprise 106, such as, by way of example and not limitation, via computing device 104. Many types of software and/or applications may be made available for user 102 to purchase and/or use, such as, for example and not limitation, by paying on a per-use basis, hourly basis, and/or indefinite basis (such as, for example, by purchasing a license therefor). Other software and/or application payment arrangements may be used as well, as may be apparent to those skilled in the relevant art(s) after reading the description herein. By way of example and not limitation, software that may be purchased may include LexisNexis® (available from LexisNexis Group of New York, N.Y.), TurboTax® (available from Intuit Inc. of Mountain View, Calif.), Westlaw® (available from Thomson Reuters Corporation of New York, N.Y.), and the like. Regardless of how payment may be determined, user 102 may be rewarded with one or more investment opportunities for purchasing and/or using software and/or application(s) from enterprise 106.

At step 408, user 102 is presented with at least one investment opportunity which may, in some aspects, be obtained for little or no cost to user 102 as a reward for submitting at least one type of interaction to at least one enterprise 106. By way of example and not limitation, the at least one investment opportunity may be presented via a graphical user interface associated with computing device 104. In some nonlimiting exemplary embodiments, the at least one investment opportunity may be presented via computing device 104 in the form of a phone call, voicemail, text message, pop-up display notification, web page display, email, instant message (IM), MMS message, SMS message, facsimile, page, or via any similar means as may be apparent to those skilled in the relevant art(s) after reading the description herein, any of which may be accompanied with a sound, vibration, light illumination, or similar attention-getting mechanism. By way of further example and not limitation, the at least one investment opportunity may comprise the opportunity to obtain one or more shares of stock, the opportunity to obtain at least partial ownership of one or more parcels of land, the opportunity to obtain at least partial ownership of one or more real estate properties, the opportunity to obtain one or more bonds, the opportunity to obtain one or more precious metals, the opportunity to obtain one or more precious stones, the opportunity to obtain one or more rare items and/or antiques, as well as any similar investment opportunities to generate wealth as may be apparent to those skilled in the relevant art(s) after reading the description herein.

At step 410, user 102 selects at least one investment to receive. By way of example and not limitation, the selection may be received from user 102 by user 102 clicking on or otherwise selecting one or more desired investment opportunities or by clicking on or otherwise selecting one or more check boxes or radio buttons associated with one or more desired investment opportunities via a graphical user interface associated with computing device 104 and/or by using one or more input devices, such as a mouse, keyboard, touchscreen, joystick, microphone, camera, and the like, that may be associated with computing device 104 to select one or more desired investment opportunities and/or check box(es) or radio button(s) associated therewith, or by any similar appropriate means as may be apparent to those skilled in the relevant art(s) after reading the description herein.

In order to make a more informed decision, in some aspects, user 102 may obtain more information regarding one or more investment opportunities before making a selection. By way of example and not limitation, this information may be obtained by clicking on or otherwise selecting one or more investment opportunities for which more information is desired or by clicking on or otherwise selecting one or more check boxes or radio buttons associated with one or more investment opportunities for which more information is desired via a graphical user interface associated with computing device 104 and/or by using one or more input devices, such as a mouse, keyboard, touchscreen, joystick, microphone, camera, and the like, that may be associated with computing device 104 to select one or more investment opportunities for which more information is desired (or one or more check boxes or radio buttons associated therewith) in order to be presented with the additional desired information, or by using a mouse or other pointer device to “hover” over one or more investment opportunities for which more information is desired until a pop-up notification, hover box, and/or sound is presented via a graphical user interface associated with computing device 104 that delivers the desired additional information. In some aspects, information regarding one or more investment opportunities may comprise price history, forecast analysis, market trend information, and/or financial indicators, as well as any similar information as may be apparent to those skilled in the relevant art(s) after reading the description herein. By way of further example and not limitation, in some nonlimiting exemplary embodiments, information regarding one or more investment opportunities may be previously stored within and later retrieved form investment database 130 (not shown in FIG. 4) and/or retrieved from Internet 134 (not shown in FIG. 4) such as, by way of example and not limitation, by using the Google® search engine (available from Google Inc. of Mountain View, Calif.).

At step 412, user 102 receives the selected investment(s), which may be delivered via any appropriate means as may be apparent to those skilled in the relevant art(s) after reading the description herein. By way of example and not limitation, in aspects wherein the investment(s) may comprise the receipt of one or more shares of stock, user 102 may provide enterprise 106 with any necessary brokerage account information needed to distribute or deliver the share(s) to one or more brokerage accounts associated with user 102 (or this information may be previously uploaded to and stored in and retrieved from, as a nonlimiting example, user database 126). In some aspects, the distribution or delivery of investment(s) may be done electronically such as, by way of example and not limitation, via computing device 104. In some additional aspects, any costs or fees that may be associated with the distribution or delivery of the investment(s) to user 102, including the cost of the investment(s) itself, may be paid for or waived by enterprise 106 or a third party, thereby allowing user 102 to receive the investment(s) at little or no cost. User 102 may provide other required information needed to obtain other types of investment(s) as necessary, such as, by way of example and not limitation, an address or meeting location, or such information may be previously uploaded to and stored in and retrieved from, as a nonlimiting example, user database 126.

At step 414, user 102 terminates the open session within system 100. All communication between user 102 computing device 104 and system 100 may be closed. In some aspects, user 102 may log out of system 100, though this may not be necessary.

In various aspects, steps 404 and 414 of process 400 may be omitted, as user 102 may not be required to log in or log out of system 100.

At step 416 process 400 is terminated and process 400 ends.

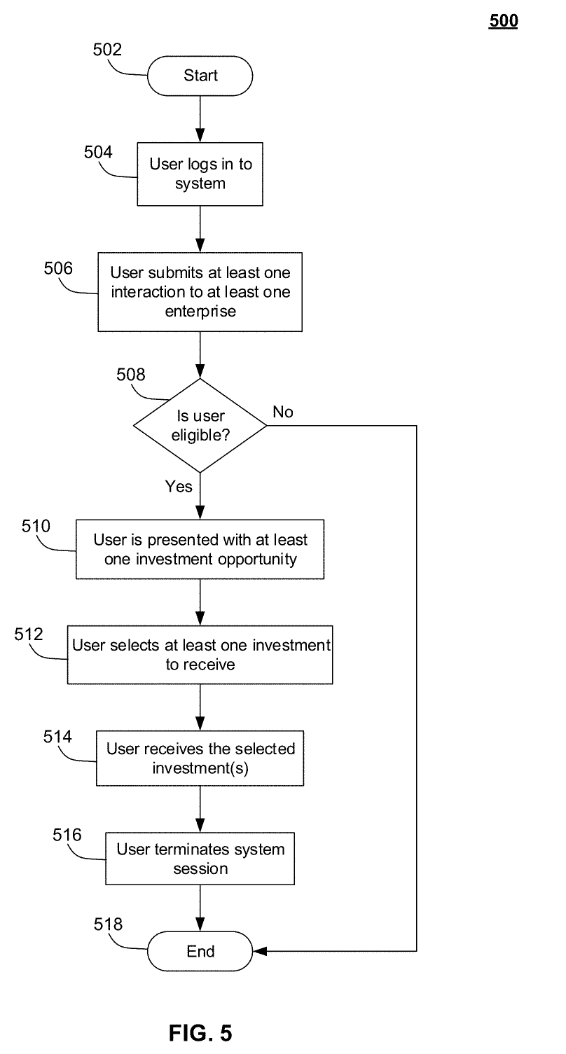

Referring now to FIG. 5, a flowchart illustrating an exemplary process 500 for distributing one or more investment opportunities to at least one user 102 who meets at least one eligibility requirement as a reward for interacting with an enterprise, according to an aspect of the present disclosure, is shown.

Process 500, which may at least partially execute within system 100 (not shown in FIG. 5), begins at step 502 with control passing immediately to step 504.

At step 504, a user 102 (not shown in FIG. 5) logs in to system 100 via a computing device 104 (not shown in FIG. 5). In some aspects, user 102 or computing device 104 may provide login credentials, thereby allowing access to an account or profile associated with user 102. By way of example and not limitation, the login credentials may take place via a software application, a website, a web application, or the like accessed by computing device 104. By way of further example and not limitation, login credentials may comprise a username, password, passcode, key code, pin number, visual identification, fingerprint scan, retinal scan, voice authentication, and/or any similar identifying and/or security elements as may be apparent to those skilled in the relevant art(s) after reading the description herein as being able to securely determine the identity of user 102. In some aspects, user 102 may login using a login service such as a social media login service, an identity/credential provider service, a single sign on service, and the like. In various aspects, users 102 may create user 102 accounts/profiles via such login services. Any user 102 accounts/profiles may, in some aspects, be stored within and retrieved from user database 126 (not shown in FIG. 5). Once user 102 has successfully logged in to system 100, process 500 proceeds to step 506.

At step 506, user 102 submits at least one type of interaction to at least one enterprise 106 (not shown in FIG. 5). In some aspects, the interaction may comprise a transaction in the form of, for example and not limitation, a purchase, sale, exchange, gift, donation, and/or similar dealing. The transaction may take place in person, such as at a physical store, restaurant, gym, church, or similar location; or, the transaction may take place via one or more online means utilizing system 100, such as via a website displayed upon a graphical user interface associated with computing device 104 configured to receive one or more inputs from user 102 via at least one input device, such as a keyboard, touchscreen, mouse, joystick, microphone, camera, and the like.

In some additional aspects, the at least one interaction with enterprise 106 may comprise at least one type of engagement with a website, blog, social media network/site/page/account, or similar online portal or site associated with enterprise 106 using computing device 104 and/or one or more input devices that may be associated therewith, such as a mouse, keyboard, touchscreen, joystick, microphone, camera, and the like. By way of example and not limitation, such engagement may comprise user 102 visiting a website, blog, and/or social media network/site/page/account of enterprise 106; “liking,” commenting, posting, reposting, private messaging, video chatting, tagging, sharing, “friending” (sending or receiving a friend request and/or friend confirmation), or otherwise interacting or interfacing with enterprise 106 and/or content posted thereby on a Facebook® (available from Facebook, Inc. of Menlo Park, Calif.) page associated with enterprise 106; “tweeting,” “retweeting,” “liking,” “following,” direct messaging, or otherwise interacting or interfacing with enterprise 106 and/or content posted thereby on a Twitter® (available from Twitter Inc. of San Francisco, Calif.) account associated with enterprise 106; connecting with, viewing, messaging, or otherwise interacting or interfacing with content available on a LinkedIn® (available from LinkedIn Corporation of Sunnyvale, Calif.) account associated with enterprise 106; and/or otherwise engaging with any of a variety of similar social media accounts associated with enterprise 106, including but not limited to Instagram® (available from Instagram, LLC of San Francisco, Calif.), Snapchat® (available from Snapchat, Inc. of Los Angeles, Calif.), and similar social media networks or services as may be apparent to those skilled in the relevant art(s) after reading the description herein. By way of further example and not limitation, online engagement with enterprise 106 may comprise several other types of interaction, such as user 102 making one or more “clicks” (e.g., selections on a graphical user interface via one or more input devices associated with computing device 104) on content available on a website, blog, or social media network/site/page/account associated with enterprise 106 utilizing one or more input devices, such as a keyboard, touchscreen, mouse, joystick, microphone, camera, that may be associated with computing device 104; spending a certain amount of time visiting a website, blog, and/or social media network/site/page/account associated with enterprise 106 and/or visiting such websites, blogs, and/or social media networks/sites/pages/accounts with a certain frequency; inviting one or more other users 102 to “friend,” “follow,” “like,” “join,” or otherwise connect with enterprise 106 on one or more social media networks/sites/pages/accounts, blogs, and/or websites associated therewith and/or receiving one or more such invitations; and/or uploading content to a website, blog, and/or social media network/site/page/account associated with enterprise 106. In some additional nonlimiting exemplary embodiments, user 102 may be credited with an interaction with enterprise 106 (or an at least partial interaction) when one or more associates such as friends, relatives, and/or acquaintances of user 102 interact with enterprise 106 on one or more websites, blogs, social media networks/sites/pages/accounts, and/or other online portals or sites (such associates may be verified, in some aspects, by way of example and not limitation, by data within a social media network associated with user 102).

In still some additional aspects, the at least one interaction with enterprise 106 may comprise purchasing and/or using software and/or one or more computer application(s) offered by enterprise 106, such as, by way of example and not limitation, via computing device 104. Many types of software and/or applications may be made available for user 102 to purchase and/or use, such as, for example and not limitation, by paying on a per-use basis, hourly basis, and/or indefinite basis (such as, for example, by purchasing a license therefor). Other software and/or application payment arrangements may be used as well, as may be apparent to those skilled in the relevant art(s) after reading the description herein. By way of example and not limitation, software that may be purchased may include LexisNexis® (available from LexisNexis Group of New York, N.Y.), TurboTax® (available from Intuit Inc. of Mountain View, Calif.), Westlaw® (available from Thomson Reuters Corporation of New York, N.Y.), and the like. Regardless of how payment may be determined, user 102 may be rewarded with one or more investment opportunities for purchasing and/or using software and/or application(s) from enterprise 106.

At step 508, it is determined whether user 102 is eligible to receive one or more investments from at least one enterprise 106. Such determination may be made at least partially based on whether user 102 meets one or more certain criteria. By way of example and not limitation, criteria that may have to be met by user 102 in order to receive investment(s) from enterprise 106 may include: being a U.S. citizen or legal U.S. resident; being at least 18 years old at the time of receiving the investment(s); being a consumer, customer, patron, visitor, member, sponsor, and/or having a similar relationship with enterprise 106 and/or having at least one previous interaction with enterprise 106 during at least a year before receiving any investment(s) therefrom; having not received any investment(s) from enterprise 106 previously; completing at least one survey providing one or more opinions, loyalties, recommendations, experiences, interactions, likes, dislikes, ratings, reactions, or other feedback to enterprise 106; providing at least one form of legally accepted photo identification at the time the investment(s) may be received; having at least one brokerage account in the U.S.; being a registered and/or active member of a membership group associated with enterprise 106 (and, in some aspects, being a member of the group for a certain amount of time); having a certain number of friends, relatives, and/or acquaintances be registered and/or active members of a membership group associated with enterprise 106 (and, in some aspects, having them be members of the group for a certain amount of time); as well as any similar appropriate criteria as may be apparent to those skilled in the relevant art(s) after reading the description herein. In some aspects wherein user 102 may be between 13 and 18 years old, a parent or legal guardian may provide authorization for that user 102 to receive one or more investment(s) offered by enterprise 106 or such users 102 may wait until they are 18 years old to obtain their investment(s). In some additional nonlimiting exemplary embodiments, the determination of whether user 102 is eligible to receive investment(s) from enterprise 106 may be at least partially determined by retrieving data previously uploaded to and stored in, by way of example and not limitation, user database 126 and comparting it against a list of requirements, either manually or via, for example and not limitation, computing device 104.

If the determination is in the affirmative, process 500 proceeds to step 510; if the determination is negative, process 500 proceeds to step 518.

At step 510, user 102 is presented with at least one investment opportunity, which may, in some aspects, be obtained for little or no cost to user 102 as a reward for submitting at least one type of interaction to at least one enterprise 106. By way of example and not limitation, the at least one investment opportunity may be presented via a graphical user interface associated with computing device 104. In some nonlimiting exemplary embodiments, the at least one investment opportunity may be presented via computing device 104 in the form of a phone call, voicemail, text message, pop-up display notification, web page display, email, instant message (IM), MMS message, SMS message, facsimile, page, or via any similar means as may be apparent to those skilled in the relevant art(s) after reading the description herein, any of which may be accompanied with a sound, vibration, light illumination, or similar attention-getting mechanism. By way of further example and not limitation, the at least one investment opportunity may comprise the opportunity to obtain one or more shares of stock, the opportunity to obtain at least partial ownership of one or more parcels of land, the opportunity to obtain at least partial ownership of one or more real estate properties, the opportunity to obtain one or more bonds, the opportunity to obtain one or more precious metals, the opportunity to obtain one or more precious stones, the opportunity to obtain one or more rare items and/or antiques, as well as any similar investment opportunities to generate wealth as may be apparent to those skilled in the relevant art(s) after reading the description herein.

At step 512, user 102 selects at least one investment to receive. By way of example and not limitation, the selection may be received from user 102 by user 102 clicking on or otherwise selecting one or more desired investment opportunities or by clicking on or otherwise selecting one or more check boxes or radio buttons associated with one or more desired investment opportunities via a graphical user interface associated with computing device 104 and/or by using one or more input devices, such as a mouse, keyboard, touchscreen, joystick, microphone, camera, and the like, that may be associated with computing device 104 to select one or more desired investment opportunities and/or check box(es) or radio button(s) associated therewith, or by any similar appropriate means as may be apparent to those skilled in the relevant art(s) after reading the description herein.

In order to make a more informed decision, in some aspects, user 102 may obtain more information regarding one or more investment opportunities before making a selection. By way of example and not limitation, this information may be obtained by clicking on or otherwise selecting one or more investment opportunities for which more information is desired or by clicking on or otherwise selecting one or more check boxes or radio buttons associated with one or more investment opportunities for which more information is desired via a graphical user interface associated with computing device 104 and/or by using one or more input devices, such as a mouse, keyboard, touchscreen, joystick, microphone, camera, and the like, that may be associated with computing device 104 to select one or more investment opportunities for which more information is desired (or one or more check boxes or radio buttons associated therewith) in order to be presented with the additional desired information, or by using a mouse or other pointer device to “hover” over one or more investment opportunities for which more information is desired until a pop-up notification, hover box, and/or sound is presented via a graphical user interface associated with computing device 104 that delivers the desired additional information. In some aspects, information regarding one or more investment opportunities may comprise price history, forecast analysis, market trend information, and/or financial indicators, as well as any similar information as may be apparent to those skilled in the relevant art(s) after reading the description herein. By way of further example and not limitation, in some nonlimiting exemplary embodiments, information regarding one or more investment opportunities may be previously stored within and later retrieved form investment database 130 (not shown in FIG. 5) and/or retrieved from Internet 134 (not shown in FIG. 5) such as, by way of example and not limitation, by using the Google® search engine (available from Google Inc. of Mountain View, Calif.).

At step 514, user 102 receives the selected investment(s), which may be delivered via any appropriate means as may be apparent to those skilled in the relevant art(s) after reading the description herein. By way of example and not limitation, in aspects wherein the investment(s) may comprise the receipt of one or more shares of stock, user 102 may provide enterprise 106 with any necessary brokerage account information needed to distribute or deliver the share(s) to one or more brokerage accounts associated with user 102 (or this information may be previously uploaded to and stored in and retrieved from, as a nonlimiting example, user database 126). In some aspects, the distribution or delivery of investment(s) may be done electronically such as, by way of example and not limitation, via computing device 104. In some additional aspects, any costs or fees that may be associated with the distribution or delivery of the investment(s) to user 102, including the cost of the investment(s) itself, may be paid for or waived by enterprise 106 or a third party, thereby allowing user 102 to receive the investment(s) at little or no cost. User 102 may provide other required information needed to obtain other types of investment(s) as necessary, such as, by way of example and not limitation, an address or meeting location, or such information may be previously uploaded to and stored in and retrieved from, as a nonlimiting example, user database 126.

At step 516, user 102 terminates the open session within system 100. All communication between user 102 computing device 104 and system 100 may be closed. In some aspects, user 102 may log out of system 100, though this may not be necessary.

In various aspects, steps 504 and 516 of process 500 may be omitted, as user 102 may not be required to log in or log out of system 100.

At step 518 process 500 is terminated and process 500 ends.

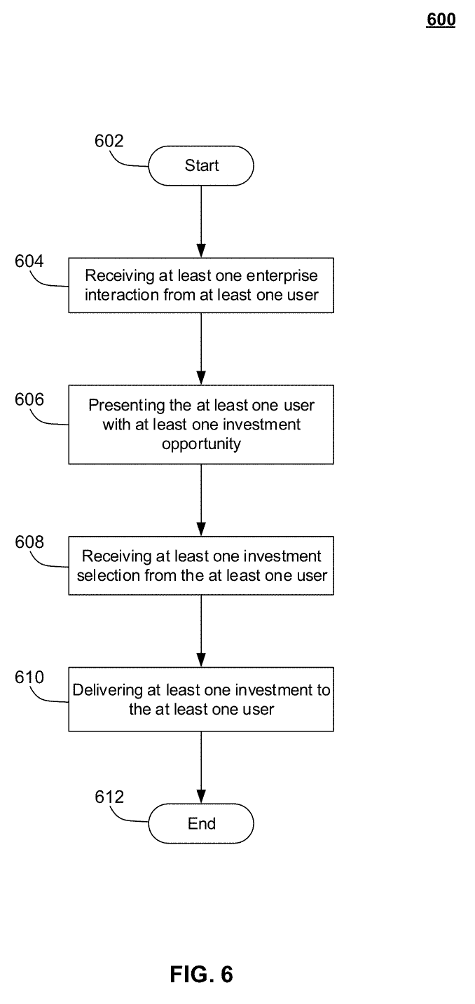

Referring now to FIG. 6, a flowchart illustrating an exemplary process 600 for distributing one or more investment opportunities to at least one user 102 upon receiving at least one enterprise 106 interaction, according to an aspect of the present disclosure, is shown.

Process 600, which may at least partially execute within system 100 (not shown in FIG. 6), begins at step 602 with control passing immediately to step 604.

At step 604, system 100 receives at least one enterprise 106 (not shown in FIG. 6) interaction from at least one user 102 (not shown in FIG. 6). In some aspects, the at least one enterprise 106 interaction may be received via computing device 104 (not shown in FIG. 6) and/or enterprise transaction device 108 (not shown in FIG. 6). In some additional aspects, the at least one enterprise 106 interaction may comprise a transaction between user 102 and at least one enterprise 106, such as, for example and not limitation, a purchase, sale, exchange, gift, donation, and/or similar dealing. In some nonlimiting exemplary embodiments, the at least one enterprise 106 interaction may be received via a website displayed upon a graphical user interface associated with computing device 104 and/or enterprise transaction device 108 configured to receive one or more inputs from user 102 via at least one input device, such as a keyboard, touchscreen, mouse, joystick, microphone, camera, scanner, chip reader, card reader, magnetic stripe reader, near field communication technology, and the like.

In some additional aspects, the at least one enterprise 106 interaction received from at least one user 102 may comprise at least one type of engagement with a website, blog, social media network/site/page/account, or similar online portal or site associated with enterprise 106 using computing device 104 and/or enterprise transaction device 108 and/or one or more input devices that may be associated therewith, such as a mouse, keyboard, touchscreen, joystick, microphone, camera, and the like. By way of example and not limitation, such engagement may comprise user 102 visiting a website, blog, and/or social media network/site/page/account of enterprise 106 using computing device 104 and/or enterprise transaction device 108; “liking,” commenting, posting, reposting, private messaging, video chatting, tagging, sharing, “friending” (sending or receiving a friend request and/or friend confirmation), or otherwise interacting or interfacing with enterprise 106 and/or content posted thereby on a Facebook® (available from Facebook, Inc. of Menlo Park, Calif.) page associated with enterprise 106 using computing device 104 and/or enterprise transaction device 108; “tweeting,” “retweeting,” “liking,” “following,” direct messaging, or otherwise interacting or interfacing with enterprise 106 and/or content posted thereby on a Twitter® (available from Twitter Inc. of San Francisco, Calif.) account associated with enterprise 106 using computing device 104 and/or enterprise transaction device 108; connecting with, viewing, messaging, or otherwise interacting or interfacing with content available on a LinkedIn® (available from LinkedIn Corporation of Sunnyvale, Calif.) account associated with enterprise 106 using computing device 104 and/or enterprise transaction device 108; and/or otherwise engaging with any of a variety of similar social media accounts associated with enterprise 106, including but not limited to Instagram® (available from Instagram, LLC of San Francisco, Calif.), Snapchat® (available from Snapchat, Inc. of Los Angeles, Calif.), and similar social media networks or services as may be apparent to those skilled in the relevant art(s) after reading the description herein using computing device 104 and/or enterprise transaction device 108. By way of further example and not limitation, online engagement with enterprise 106 may comprise several other types of enterprise 106 interactions, such as user 102 making one or more “clicks” (e.g., selections on a graphical user interface via one or more input devices associated with computing device 104 and/or enterprise transaction device 108) on content available on a website, blog, or social media network/site/page/account associated with enterprise 106 utilizing one or more input devices, such as a keyboard, touchscreen, mouse, joystick, microphone, camera, that may be associated with computing device 104 and/or enterprise transaction device 108; spending a certain amount of time visiting a website, blog, and/or social media network/site/page/account associated with enterprise 106 using computing device 104 and/or enterprise transaction device 108 and/or visiting such websites, blogs, and/or social media networks/sites/pages/accounts with a certain frequency; inviting other users 102 to “friend,” “follow,” “like,” “join,” or otherwise connect with enterprise 106 on one or more social media networks/sites/pages/accounts, blogs, and/or websites associated therewith and/or receiving one or more such invitations via computing device 104 and/or enterprise transaction device 108; and/or uploading content to a website, blog, and/or social media network/site/page/account associated with enterprise 106 using computing device 104 and/or enterprise transaction device 108. In some additional nonlimiting exemplary embodiments, an enterprise 106 interaction (or an at least partial interaction) may be received from a user 102 when at least one enterprise 106 interaction is received from one or more associates such as friends, relatives, and/or acquaintances of user 102 via one or more websites, blogs, social media networks/sites/pages/accounts, and/or other online portals or sites using various computing devices 104 and/or enterprise transaction device 108 (such associates may be verified, in some aspects, by way of example and not limitation, by data obtained from a social media network associated with user 102).

In still some additional aspects, the at least one enterprise 106 interaction may comprise user 102 purchasing and/or using software and/or one or more computer application(s) offered by enterprise 106, such as, by way of example and not limitation, via computing device 104 and/or enterprise transaction device 108. Many types of software and/or applications may be made available from enterprise 106 for user 102 to purchase and/or use, such as, for example and not limitation, by paying on a per-use basis, hourly basis, and/or indefinite basis (such as, for example, by purchasing a license therefor). Other software and/or application payment arrangements may be used as well, as may be apparent to those skilled in the relevant art(s) after reading the description herein. By way of example and not limitation, software that may be purchased may include LexisNexis® (available from LexisNexis Group of New York, N.Y.), TurboTax® (available from Intuit Inc. of Mountain View, Calif.), Westlaw® (available from Thomson Reuters Corporation of New York, N.Y.), and the like. Regardless of how payment may be determined, user 102 may be rewarded for purchasing and/or using software and/or application(s) from enterprise 106 by receiving one or more investment opportunities from enterprise 106.

At step 606, system 100 presents the at least one user 102 with at least one investment opportunity which may, in some aspects, be obtained for little or no cost to user 102 as a reward for engaging in at least one enterprise 106 interaction. By way of example and not limitation, the at least one investment opportunity may be presented via a graphical user interface associated with computing device 104 and/or enterprise transaction device 108. In some nonlimiting exemplary embodiments, the at least one investment opportunity may be presented via computing device 104 and/or enterprise transaction device 108 in the form of a phone call, voicemail, text message, pop-up display notification, web page display, email, instant message (IM), MMS message, SMS message, facsimile, page, or via any similar means as may be apparent to those skilled in the relevant art(s) after reading the description herein, any of which may be accompanied with a sound, vibration, light illumination, or similar attention-getting mechanism. By way of further example and not limitation, the at least one investment opportunity may comprise the opportunity for user 102 to obtain one or more shares of stock, to obtain at least partial ownership of one or more parcels of land, to obtain at least partial ownership of one or more real estate properties, to obtain one or more bonds, to obtain one or more precious metals, to obtain one or more precious stones, to obtain one or more rare items and/or antiques, as well as any similar investment opportunities to generate wealth as may be apparent to those skilled in the relevant art(s) after reading the description herein.

At step 608, system 100 receives at least one investment selection from the at least one user 102. By way of example and not limitation, the selection may be received from user 102 by user 102 clicking on or otherwise selecting one or more desired investment opportunities or by clicking on or otherwise selecting one or more check boxes or radio buttons associated with one or more desired investment opportunities via a graphical user interface associated with computing device 104 and/or enterprise transaction device 108 and/or by using one or more input devices, such as a mouse, keyboard, touchscreen, joystick, microphone, camera, and the like, that may be associated with computing device 104 and/or enterprise transaction device 108 to select one or more desired investment opportunities and/or check box(es) or radio button(s) associated therewith, or by any similar appropriate means as may be apparent to those skilled in the relevant art(s) after reading the description herein.

In order to make a more informed decision, in some aspects, user 102 may obtain more information regarding one or more investment opportunities before making a selection. By way of example and not limitation, this information may be obtained by clicking on or otherwise selecting one or more investment opportunities for which more information is desired or by clicking on or otherwise selecting one or more check boxes or radio buttons associated with one or more investment opportunities for which more information is desired via a graphical user interface associated with computing device 104 and/or enterprise transaction device 108 and/or by using one or more input devices, such as a mouse, keyboard, touchscreen, joystick, microphone, camera, and the like, that may be associated with computing device 104 and/or enterprise transaction device 108 to select one or more investment opportunities for which more information is desired (or one or more check boxes or radio buttons associated therewith) in order to be presented with the additional desired information, or by using a mouse or other pointer device to “hover” over one or more investment opportunities for which more information is desired until a pop-up notification, hover box, and/or sound is presented via a graphical user interface associated with computing device 104 and/or enterprise transaction device 108 that delivers the desired additional information. In some aspects, information regarding one or more investment opportunities may comprise price history, forecast analysis, market trend information, and/or financial indicators, as well as any similar information as may be apparent to those skilled in the relevant art(s) after reading the description herein. By way of further example and not limitation, in some nonlimiting exemplary embodiments, information regarding one or more investment opportunities may be previously stored within and later retrieved form investment database 130 (not shown in FIG. 6) and/or retrieved from Internet 134 (not shown in FIG. 6) such as, by way of example and not limitation, by using the Google® search engine (available from Google Inc. of Mountain View, Calif.) via, for example and not limitation, computing device 104 and/or enterprise transaction device 108.

At step 610, system 100 facilitates delivery of at least one selected investment to the at least one user 102. The at least one investment may be delivered using any appropriate means as may be apparent to those skilled in the relevant art(s) after reading the description herein. By way of example and not limitation, in aspects wherein the investment(s) may comprise one or more shares of stock, user 102 may provide enterprise 106 with any necessary brokerage account information needed to distribute or deliver the share(s) to one or more brokerage accounts associated with user 102 (or this brokerage account information may be previously uploaded to and stored in and retrieved from, as a nonlimiting example, user database 126 (not shown in FIG. 6)). In some aspects, the distribution or delivery of investment(s) may be done electronically such as, by way of example and not limitation, via computing device 104 and/or enterprise transaction device 108. In some additional aspects, any costs or fees that may be associated with the distribution or delivery of the investment(s) to user 102, including the cost of the investment(s) itself, may be paid for or waived by enterprise 106 or a third party, thereby allowing user 102 to receive the investment(s) at little or no cost. User 102 may provide other required information needed to obtain other types of investment(s) as necessary, such as, by way of example and not limitation, an address or meeting location, or such information may be previously uploaded to and stored in and retrieved from, as a nonlimiting example, user database 126.

At step 612, process 600 is terminated and process 600 ends.

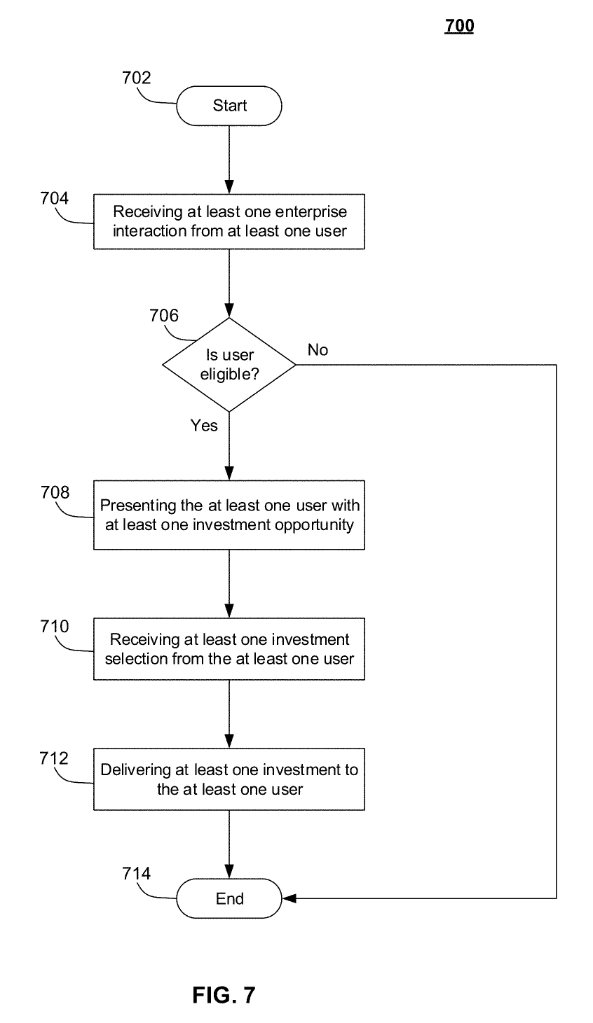

Referring now to FIG. 7, a flowchart illustrating an exemplary process 700 for distributing one or more investment opportunities to at least one user 102 who meets at least one eligibility requirement upon receiving at least one enterprise 106 interaction, according to an aspect of the present disclosure, is shown.

Process 700, which may at least partially execute within system 100 (not shown in FIG. 7), begins at step 702 with control passing immediately to step 704.

At step 704, system 100 receives at least one enterprise 106 (not shown in FIG. 7) interaction from at least one user 102 (not shown in FIG. 7). In some aspects, the at least one enterprise 106 interaction may be received via computing device 104 (not shown in FIG. 7) and/or enterprise transaction device 108 (not shown in FIG. 7). In some additional aspects, the at least one enterprise 106 interaction may comprise a transaction between user 102 and at least one enterprise 106, such as, for example and not limitation, a purchase, sale, exchange, gift, donation, and/or similar dealing. In some nonlimiting exemplary embodiments, the at least one enterprise 106 interaction may be received via a website displayed upon a graphical user interface associated with computing device 104 and/or enterprise transaction device 108 configured to receive one or more inputs from user 102 via at least one input device, such as a keyboard, touchscreen, mouse, joystick, microphone, camera, scanner, chip reader, card reader, magnetic stripe reader, near field communication technology, and the like.

In some additional aspects, the at least one enterprise 106 interaction received from at least one user 102 may comprise at least one type of engagement with a website, blog, social media network/site/page/account, or similar online portal or site associated with enterprise 106 using computing device 104 and/or enterprise transaction device 108 and/or one or more input devices that may be associated therewith, such as a mouse, keyboard, touchscreen, joystick, microphone, camera, and the like. By way of example and not limitation, such engagement may comprise user 102 visiting a website, blog, and/or social media network/site/page/account of enterprise 106 using computing device 104 and/or enterprise transaction device 108; “liking,” commenting, posting, reposting, private messaging, video chatting, tagging, sharing, “friending” (sending or receiving a friend request and/or friend confirmation), or otherwise interacting or interfacing with enterprise 106 and/or content posted thereby on a Facebook® (available from Facebook, Inc. of Menlo Park, Calif.) page associated with enterprise 106 using computing device 104 and/or enterprise transaction device 108; “tweeting,” “retweeting,” “liking,” “following,” direct messaging, or otherwise interacting or interfacing with enterprise 106 and/or content posted thereby on a Twitter® (available from Twitter Inc. of San Francisco, Calif.) account associated with enterprise 106 using computing device 104 and/or enterprise transaction device 108; connecting with, viewing, messaging, or otherwise interacting or interfacing with content available on a LinkedIn® (available from LinkedIn Corporation of Sunnyvale, Calif.) account associated with enterprise 106 using computing device 104 and/or enterprise transaction device 108; and/or otherwise engaging with any of a variety of similar social media accounts associated with enterprise 106, including but not limited to Instagram® (available from Instagram, LLC of San Francisco, Calif.), Snapchat® (available from Snapchat, Inc. of Los Angeles, Calif.), and similar social media networks or services as may be apparent to those skilled in the relevant art(s) after reading the description herein using computing device 104 and/or enterprise transaction device 108. By way of further example and not limitation, online engagement with enterprise 106 may comprise several other types of enterprise 106 interactions, such as user 102 making one or more “clicks” (e.g., selections on a graphical user interface via one or more input devices associated with computing device 104 and/or enterprise transaction device 108) on content available on a website, blog, or social media network/site/page/account associated with enterprise 106 utilizing one or more input devices, such as a keyboard, touchscreen, mouse, joystick, microphone, camera, that may be associated with computing device 104 and/or enterprise transaction device 108; spending a certain amount of time visiting a website, blog, and/or social media network/site/page/account associated with enterprise 106 using computing device 104 and/or enterprise transaction device 108 and/or visiting such websites, blogs, and/or social media networks/sites/pages/accounts with a certain frequency; inviting other users 102 to “friend,” “follow,” “like,” “join,” or otherwise connect with enterprise 106 on one or more social media networks/sites/pages/accounts, blogs, and/or websites associated therewith and/or receiving one or more such invitations via computing device 104 and/or enterprise transaction device 108; and/or uploading content to a website, blog, and/or social media network/site/page/account associated with enterprise 106 using computing device 104 and/or enterprise transaction device 108. In some additional nonlimiting exemplary embodiments, an enterprise 106 interaction (or an at least partial interaction) may be received from a user 102 when at least one enterprise 106 interaction is received from one or more associates such as friends, relatives, and/or acquaintances of user 102 via one or more websites, blogs, social media networks/sites/pages/accounts, and/or other online portals or sites using various computing devices 104 and/or enterprise transaction device 108 (such associates may be verified, in some aspects, by way of example and not limitation, by data obtained from a social media network associated with user 102).

In still some additional aspects, the at least one enterprise 106 interaction may comprise user 102 purchasing and/or using software and/or one or more computer application(s) offered by enterprise 106, such as, by way of example and not limitation, via computing device 104 and/or enterprise transaction device 108. Many types of software and/or applications may be made available from enterprise 106 for user 102 to purchase and/or use, such as, for example and not limitation, by paying on a per-use basis, hourly basis, and/or indefinite basis (such as, for example, by purchasing a license therefor). Other software and/or application payment arrangements may be used as well, as may be apparent to those skilled in the relevant art(s) after reading the description herein. By way of example and not limitation, software that may be purchased may include LexisNexis® (available from LexisNexis Group of New York, N.Y.), TurboTax® (available from Intuit Inc. of Mountain View, Calif.), Westlaw® (available from Thomson Reuters Corporation of New York, N.Y.), and the like. Regardless of how payment may be determined, user 102 may be rewarded for purchasing and/or using software and/or application(s) from enterprise 106 by receiving one or more investment opportunities from enterprise 106.

At step 706, system 100 determines whether user 102 is eligible to receive one or more investments from at least one enterprise 106. Such determination may be made at least partially based on whether user 102 meets one or more certain criteria. By way of example and not limitation, criteria that may have to be met by user 102 in order to receive investment(s) from enterprise 106 may include: being a U.S. citizen or legal U.S. resident; being at least 18 years old at the time of receiving the investment(s); being a consumer, customer, patron, visitor, member, sponsor, and/or having a similar relationship with enterprise 106 and/or having at least one previous interaction with enterprise 106 during at least a year before receiving any investment(s) therefrom; having not received any investment(s) from enterprise 106 previously; completing at least one survey providing one or more opinions, loyalties, recommendations, experiences, interactions, likes, dislikes, ratings, reactions, or other feedback to enterprise 106; providing at least one form of legally accepted photo identification at the time the investment(s) may be received; having at least one brokerage account in the U.S.; being a registered and/or active member of a membership group associated with enterprise 106 (and, in some aspects, being a member of the group for a certain amount of time); having a certain number of friends, relatives, and/or acquaintances be registered and/or active members of a membership group associated with enterprise 106 (and, in some aspects, having them be members of the group for a certain amount of time); as well as any similar appropriate criteria as may be apparent to those skilled in the relevant art(s) after reading the description herein. In some aspects wherein user 102 may be between 13 and 18 years old, a parent or legal guardian may provide authorization for that user 102 to receive one or more investment(s) offered by enterprise 106 or such users 102 may wait until they are 18 years old to obtain their investment(s). In some additional nonlimiting exemplary embodiments, the determination of whether user 102 is eligible to receive investment(s) from enterprise 106 may be at least partially determined by retrieving data previously uploaded to and stored in, by way of example and not limitation, user database 126 (not shown in FIG. 7) and comparting it against a list of requirements, either manually or via a computing device, such as, by way of example and not limitation, computing device 104 and/or enterprise transaction device 108.

If the determination is in the affirmative, process 700 proceeds to step 708; if the determination is negative, process 700 proceeds to step 714.

At step 708, system 100 presents the at least one user 102 with at least one investment opportunity which may, in some aspects, be obtained for little or no cost to user 102 as a reward for engaging in at least one enterprise 106 interaction. By way of example and not limitation, the at least one investment opportunity may be presented via a graphical user interface associated with computing device 104 and/or enterprise transaction device 108. In some nonlimiting exemplary embodiments, the at least one investment opportunity may be presented via computing device 104 and/or enterprise transaction device 108 in the form of a phone call, voicemail, text message, pop-up display notification, web page display, email, instant message (IM), MMS message, SMS message, facsimile, page, or via any similar means as may be apparent to those skilled in the relevant art(s) after reading the description herein, any of which may be accompanied with a sound, vibration, light illumination, or similar attention-getting mechanism. By way of further example and not limitation, the at least one investment opportunity may comprise the opportunity for user 102 to obtain one or more shares of stock, to obtain at least partial ownership of one or more parcels of land, to obtain at least partial ownership of one or more real estate properties, to obtain one or more bonds, to obtain one or more precious metals, to obtain one or more precious stones, to obtain one or more rare items and/or antiques, as well as any similar investment opportunities to generate wealth as may be apparent to those skilled in the relevant art(s) after reading the description herein.

At step 710, system 100 receives at least one investment selection from the at least one user 102. By way of example and not limitation, the selection may be received from user 102 by user 102 clicking on or otherwise selecting one or more desired investment opportunities or by clicking on or otherwise selecting one or more check boxes or radio buttons associated with one or more desired investment opportunities via a graphical user interface associated with computing device 104 and/or enterprise transaction device 108 and/or by using one or more input devices, such as a mouse, keyboard, touchscreen, joystick, microphone, camera, and the like, that may be associated with computing device 104 and/or enterprise transaction device 108 to select one or more desired investment opportunities and/or check box(es) or radio button(s) associated therewith, or by any similar appropriate means as may be apparent to those skilled in the relevant art(s) after reading the description herein.

In order to make a more informed decision, in some aspects, user 102 may obtain more information regarding one or more investment opportunities before making a selection. By way of example and not limitation, this information may be obtained by clicking on or otherwise selecting one or more investment opportunities for which more information is desired or by clicking on or otherwise selecting one or more check boxes or radio buttons associated with one or more investment opportunities for which more information is desired via a graphical user interface associated with computing device 104 and/or enterprise transaction device 108 and/or by using one or more input devices, such as a mouse, keyboard, touchscreen, joystick, microphone, camera, and the like, that may be associated with computing device 104 and/or enterprise transaction device 108 to select one or more investment opportunities for which more information is desired (or one or more check boxes or radio buttons associated therewith) in order to be presented with the additional desired information, or by using a mouse or other pointer device to “hover” over one or more investment opportunities for which more information is desired until a pop-up notification, hover box, and/or sound is presented via a graphical user interface associated with computing device 104 and/or enterprise transaction device 108 that delivers the desired additional information. In some aspects, information regarding one or more investment opportunities may comprise price history, forecast analysis, market trend information, and/or financial indicators, as well as any similar information as may be apparent to those skilled in the relevant art(s) after reading the description herein. By way of further example and not limitation, in some nonlimiting exemplary embodiments, information regarding one or more investment opportunities may be previously stored within and later retrieved form investment database 130 (not shown in FIG. 7) and/or retrieved from Internet 134 (not shown in FIG. 7) such as, by way of example and not limitation, by using the Google® search engine (available from Google Inc. of Mountain View, Calif.) via, for example and not limitation, computing device 104 and/or enterprise transaction device 108.

At step 712, system 100 facilitates delivery of at least one selected investment to the at least one user 102. The at least one investment may be delivered using any appropriate means as may be apparent to those skilled in the relevant art(s) after reading the description herein. By way of example and not limitation, in aspects wherein the investment(s) may comprise one or more shares of stock, user 102 may provide enterprise 106 with any necessary brokerage account information needed to distribute or deliver the share(s) to one or more brokerage accounts associated with user 102 (or this brokerage account information may be previously uploaded to and stored in and retrieved from, as a nonlimiting example, user database 126 (not shown in FIG. 7)). In some aspects, the distribution or delivery of investment(s) may be done electronically such as, by way of example and not limitation, via computing device 104 and/or enterprise transaction device 108. In some additional aspects, any costs or fees that may be associated with the distribution or delivery of the investment(s) to user 102, including the cost of the investment(s) itself, may be paid for or waived by enterprise 106 or a third party, thereby allowing user 102 to receive the investment(s) at little or no cost. User 102 may provide other required information needed to obtain other types of investment(s) as necessary, such as, by way of example and not limitation, an address or meeting location, or such information may be previously uploaded to and stored in and retrieved from, as a nonlimiting example, user database 126.

At step 714, process 700 is terminated and process 700 ends.

It is noted that the order of the steps of processes 200-700, including the starting and/or ending points thereof, may be altered without departing from the spirit and scope of the present disclosure, as will be appreciated by those skilled in the relevant art(s) after reading the description herein.

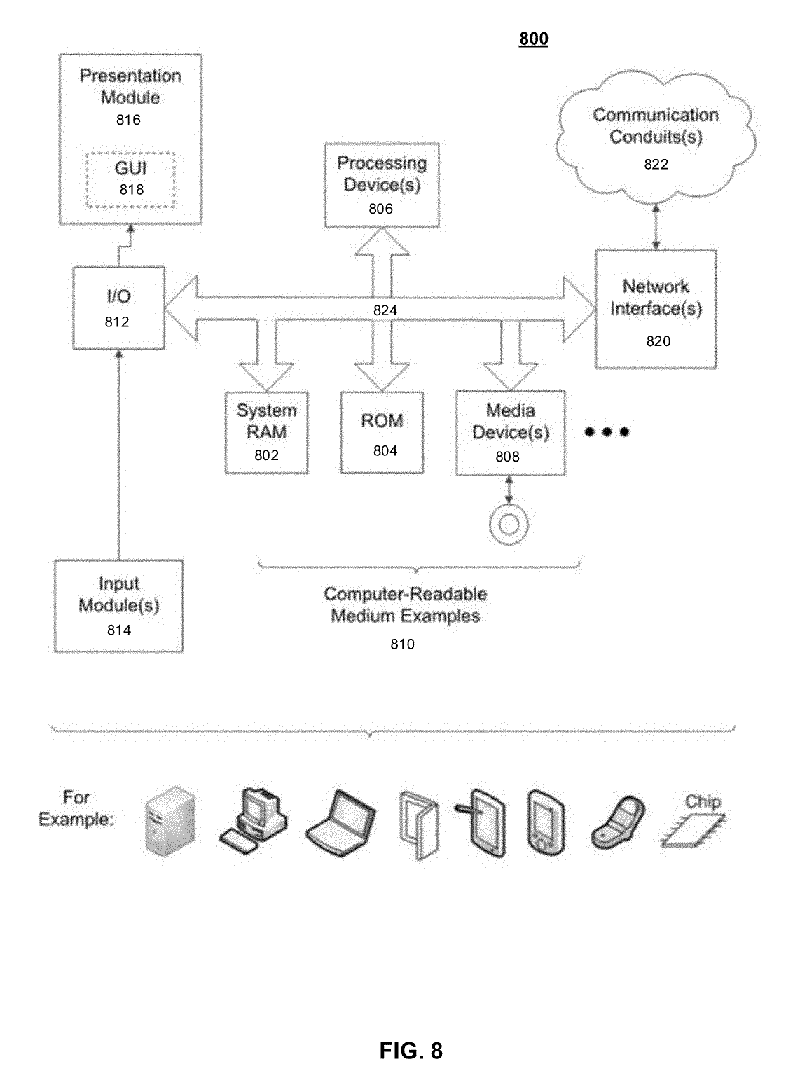

Referring now to FIG. 8, a block diagram of an exemplary computing system 800 useful for implementing one or more aspects of the present disclosure is shown.

FIG. 8 sets forth illustrative computing functionality 800 that may be used to implement web server(s) 122, application server(s) 124, one or more gateways 110-120, user database 126, enterprise database 128, investment database 130, brokerage provider database 132, computing devices 104 utilized by users 102 to access Internet 134, enterprise transaction device 108 to facilitate interaction between a given enterprise 106 and user(s) 102, or any other component of system 100. In all cases, computing functionality 800 represents one or more physical and tangible processing mechanisms.

Computing functionality 800 may comprise volatile and non-volatile memory, such as RAM 802 and ROM 804, as well as one or more processing devices 806 (e.g., one or more central processing units (CPUs), one or more graphical processing units (GPUs), and the like). Computing functionality 800 also optionally comprises various media devices 808, such as a hard disk module, an optical disk module, and so forth. Computing functionality 800 may perform various operations identified when the processing device(s) 806 execute(s) instructions that are maintained by memory (e.g., RAM 802, ROM 804, and the like).

More generally, instructions and other information may be stored on any computer readable medium 810, including, but not limited to, static memory storage devices, magnetic storage devices, and optical storage devices. The term “computer readable medium” also encompasses plural storage devices. In all cases, computer readable medium 810 represents some form of physical and tangible entity. By way of example and not limitation, computer readable medium 810 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 802, ROM 804, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as wired network or direct-wired connection, and wireless media such as acoustic, RF, infrared, and other wireless media. Combinations of any of the above are also included within the scope of computer readable medium.

Computing functionality 800 may also comprise an input/output module 812 for receiving various inputs (via input modules 814), and for providing various outputs (via one or more output modules). One particular output module mechanism may be a presentation module 816 and an associated GUI 818. Computing functionality 800 may also include one or more network interfaces 820 for exchanging data with other devices via one or more communication conduits 822. In some aspects, one or more communication buses 824 communicatively couple the above-described components together.

Communication conduit(s) 822 may be implemented in any manner (e.g., by a local area network, a wide area network (e.g., the Internet), and the like, or any combination thereof). Communication conduit(s) 822 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or any combination thereof. In the case of a software implementation, the module or component represents program code that performs specified tasks when executed on one or more processors. The program code may be stored in one or more computer readable memory devices, as described with reference to FIG. 8. The features of the present disclosure described herein are platform-independent, meaning the techniques can be implemented on a variety of commercial computing platforms having a variety of processors (e.g., desktop, laptop, notebook, tablet computer, personal digital assistant (PDA), mobile telephone, smart telephone, gaming console, and the like).

In view of the above, a non-transitory processor readable storage medium is provided. The storage medium comprises an executable computer program product which further comprises a computer software code that, when executed on a processor, causes the processor to perform certain steps or processes. Such steps may include, but are not limited to, causing the processor to receive at least one enterprise 106 interaction and/or transaction from a user 102; determine that user 102 is eligible to receive at least one investment; and if user 102 is eligible to receive at least one investment, present user 102 with at least one investment opportunity; receive at least one investment selection from user 102; and/or deliver at least one investment to user 102.

As an Internet of Things nonlimiting example, in operation, as mentioned previously, in some aspects at least one user 102 may utilize enterprise transaction device 108 to complete at least one transaction with at least one enterprise 106. Enterprise transaction device 108 may be configured to receive at least one product and/or service request from user 102 and/or receive payment therefor from user 102 via, by way of example and not limitation, a graphical user interface and one or more input devices such as a keyboard, touchscreen, mouse, joystick, microphone, camera, scanner, chip reader, card reader, magnetic stripe reader, near field communication technology, and the like. By way of further example and not limitation, payment may be received in the form of a credit or debit card, gift card, PayPal® account (available from PayPal Holdings, Inc. of San Jose, Calif.), Apple Pay® (available from Apple Inc. of Cupertino, Calif.), Google Wallet (available from Google Inc. of Mountain View, Calif.), as well as any other appropriate payment means as may be apparent to those skilled in the relevant art(s) after reading the description herein. In some additional aspects, enterprise transaction device 108 may also be configured to determine whether user 102 is eligible to receive at least one investment, and if so, present at least one investment opportunity to user 102, receive at least one investment selection from user 102, and/or deliver at least one investment to user 102, such as, by way of example and not limitation, by facilitating delivery of one or more shares of stock to user's 102 electronic brokerage account. In still some additional aspects, enterprise transaction device 108 may be configured to deliver one or more products and/or services to user 102, including but not limited to one or more DVDs, food items, beverages, as well as others as may be apparent to those skilled in the relevant art(s) after reading the description herein. For security measures, enterprise transaction device 108 may include one or more identity confirmation mechanisms, including but not limited to a keypad and/or touchscreen configured to receive input of a password, passkey, passcode, or pin number; a microphone configured to receive vocal input of a password, passkey, passcode, or pin number and/or provide for voice authentication of user 102; a touchscreen or similar mechanism to provide for fingerprint scanning; a camera or similar lens configured to receive a retinal scan; as well as any similar secure identification means as may be apparent to those skilled in the relevant art(s) after reading the description herein. In yet some additional aspects, enterprise transaction device 108 may be configured to provide more information to user 102 regarding one or more investment opportunities. By way of example and not limitation, this information may be obtained by clicking on or otherwise selecting one or more investment opportunities for which more information is desired or by clicking on or otherwise selecting one or more check boxes or radio buttons associated with one or more investment opportunities for which more information is desired via a graphical user interface associated with enterprise transaction device 108 and/or by using one or more input devices, such as a mouse, keyboard, touchscreen, joystick, microphone, camera, and the like, that may be associated with enterprise transaction device 108 to select one or more investment opportunities for which more information is desired (or one or more check boxes or radio buttons associated therewith) in order to be presented with the additional desired information, or by using a mouse or other pointer device to “hover” over one or more investment opportunities for which more information is desired until a pop-up notification, hover box, and/or sound is presented via a graphical user interface associated with enterprise transaction device 108 that delivers the desired additional information. In some aspects, information regarding one or more investment opportunities may comprise price history, forecast analysis, market trend information, and/or financial indicators, as well as any similar information as may be apparent to those skilled in the relevant art(s) after reading the description herein. By way of example and not limitation, in some nonlimiting exemplary embodiments, information regarding one or more investment opportunities may be previously stored within and later retrieved form investment database 130 and/or retrieved from Internet 134 such as, by way of example and not limitation, by using the Google® search engine (available from Google Inc. of Mountain View, Calif.).

As will be appreciated by those skilled in the relevant art(s) after reading the description herein, the disclosed systems, methods, and computer program products may be used for providing one or more different types of investment opportunities to various users for various reasons without departing from the spirit and scope of the present disclosure.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices, environments, and methods other than those mentioned herein). As will be appreciated by those skilled in the relevant art(s) after reading the description herein, certain features from different aspects of the systems, methods, and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

1. A computer-implemented method, comprising:
receiving an interaction from at least one of a user and an associate of the user, wherein the interaction is between an enterprise and the at least one of the user and the associate of the user;
determining that the user is qualified for an investment opportunity with the enterprise based on the interaction, wherein the investment opportunity is related to the enterprise;
determining the investment opportunity after the determining that the user is qualified; and
presenting an offer to participate in the investment opportunity to the user.

2. The method of claim 1, wherein the method further comprises:
increasing an amount of the investment opportunity based on a second interaction between the enterprise and the associate of the user.

3. The method of claim 1, wherein the associate of the user is linked to the user on social media.

4. The method of claim 1, wherein the enterprise comprises at least one of: a business, a retail store, a restaurant, a gym, a religious organization, a group, a merchant, a salesman, an airline, a service provider, a credit card company, a club, and a charitable organization.

5. The method of claim 1, wherein the interaction comprises at least one of: a sale to the enterprise, an exchange with the enterprise, a gift to the enterprise, a donation to the enterprise, using software provided by the enterprise, using an application provided by the enterprise, visiting a website associated with the enterprise, a content click on an online site associated with the enterprise, and a content upload to an online site associated with the enterprise.

6. The method of claim 1, wherein the interaction comprises a social media interaction comprising at least one of: a post, a comment, a like, a share, a retweet, a friend request, a friend confirmation, a follow, a tag, and a repost, and further comprising increasing an amount of the investment opportunity based on the social media interaction.

7. The method of claim 1, further comprising:
prior to determining the investment opportunity, determining whether the user satisfies at least one eligibility requirement, wherein the at least one eligibility requirement comprises at least one of: an age requirement, a residency requirement, a citizenship requirement, a legal requirement, an identification requirement, an enterprise relationship requirement, and a membership requirement; wherein the enterprise relationship requirement comprises a requirement that the at least one user has previously submitted at least one enterprise interaction to the at least one enterprise.

8. The method of claim 1, wherein the investment opportunity comprises at least one of: at least one share of stock; at least one bond; an amount of at least one precious metal; an amount of at least one precious stone; at least one rare item; at least one antique item; at least partial ownership of at least one parcel of land; and at least partial ownership of at least one real estate property.

9. The method of claim 1, wherein the investment comprises a partial ownership of the enterprise.

10. The method of claim 1, wherein the investment opportunity is provided by at least one brokerage provider and is based on the interaction.

11. A system, comprising:
a server coupled to a communication network and comprising a microprocessor and a computer-readable medium coupled thereto, wherein the microprocessor receives instructions from the computer-readable medium and is programmed to:
receive an interaction from at least one of a user and an associate of the user, wherein the interaction is between an enterprise and the at least one of the user and the associate of the user;
determine that the user is qualified for an investment opportunity with the enterprise based on the interaction, wherein the investment opportunity is related to the enterprise;
determine the investment opportunity after the determining that the user is qualified; and
present an offer to participate in the investment opportunity to the user.

12. The system as recited in claim 11, wherein the microprocessor is further programmed to:
determine that the associate of the user is qualified for a second investment opportunity with the enterprise, wherein the second investment opportunity is related to the enterprise.

13. The system as recited in claim 11, wherein the investment opportunity is selected from a plurality of investment opportunities and is selected based on the interaction.

14. The system as recited in claim 11, wherein the enterprise comprises at least one of: a business, a retail store, a restaurant, a gym, a religious organization, a group, a merchant, a salesman, an airline, a service provider, a credit card company, a club, and a charitable organization.

15. The system as recited in claim 11, wherein the interaction comprises at least one of: a sale to the enterprise, an exchange with the enterprise, a gift to the enterprise, a donation to the enterprise, using software provided by the enterprise, using an application provided by the enterprise, visiting a website associated with the enterprise, a content click on an online site associated with the enterprise, and a content upload to an online site associated with the enterprise.

16. The system as recited in claim 1, wherein the interaction is an engagement with a social media network associated with the enterprise, and wherein the engagement comprises at least one of: a post, a comment, a like, a share, a retweet, a friend request, a friend confirmation, a follow, a tag, and a repost.

17. The system as recited in claim 11, wherein the microprocessor is further programmed to determine if the user meets an eligibility requirement, and wherein the eligibility requirement comprises at least one of: an age requirement, a residency requirement, a citizenship requirement, a legal requirement, an identification requirement, an enterprise relationship requirement, and a membership requirement.

18. The system as recited in claim 11, wherein the investment comprises at least one of: at least one share of stock; at least one bond; an amount of at least one precious metal; an amount of at least one precious stone; at least one rare item; at least one antique item, at least partial ownership of at least one parcel of land; and at least partial ownership of at least one real estate property.

19. The system as recited in claim 11, wherein the investment comprises at least partial ownership of the enterprise.

20. The system as recited in claim 11, wherein the microprocessor is further programmed to receive a response from the user about the offer.
